(19) United States
(12) Patent Application Publication
(10) Pub. No.: US 2022/0053758 A1
(43) Pub. Date: Feb. 24, 2022

(54) Microcapsule With Acetamides And Diflufenican

(71) Applicant: Monsanto Technology LLC, St. Louis, MO (US)

(72) Inventors: Alejandro PEREZ-JONES, St. Peters, MO (US); Junhua ZHANG, Chesterfield, MO (US)

(73) Assignee: Monsanto Technology LLC, St. Louis, MO (US)

(21) Appl. No.: 17/406,007

(22) Filed: Aug. 18, 2021

Related U.S. Application Data
(60) Provisional application No. 63/068,264, filed on Aug. 20, 2020.
(60) Provisional application No. 63/223,264, filed on Jul. 19, 2021.

(51) Int. Cl. A01N 25/28; A01N 43/40; A01N 25/32; A01N 25/10; A01N 37/18; A01N 43/707

(52) U.S. Cl. CPC A01N 25/28; A01N 43/40; A01N 43/707; A01N 25/10; A01N 37/18; A01N 25/32

(57) ABSTRACT

The present disclosure relates to the technical field of crop protection. The present disclosure primarily relates to microcapsules comprising a polymeric shell wall and a water-immiscible core material comprising (i) an acetamide herbicide, (ii) diflufenican and (iii) an organic non-polar solvent. The present disclosure also relates to herbicidal compositions comprising these microcapsules, methods for preparing these microcapsules and methods of using these microcapsules and herbicidal compositions for controlling weeds.

### CROSS-REFERENCE TO RELATED APPLICATIONS

This application claims the benefit of, and priority to, U.S. Provisional Patent Application No. 63/068,264, filed Aug. 20, 2020, and U.S. Provisional Patent Application No. 63/223,264, filed Jul. 19, 2021. The entire disclosure of each of the above applications is incorporated herein by reference.

### FIELD

The present disclosure relates to the technical field of crop protection. The present disclosure primarily relates to microcapsules comprising a polymeric shell wall and a water-immiscible core material comprising (i) an acetamide herbicide, (ii) diflufenican and (iii) an organic non-polar solvent. The present disclosure also relates to herbicidal compositions comprising these microcapsules, methods for preparing these microcapsules and methods of using these microcapsules and herbicidal compositions for controlling weeds.

### BACKGROUND

This section provides background information related to the present disclosure which is not necessarily prior art.

Herbicide compositions containing a combination of herbicides with multiple modes of action are especially suited for controlling growth of unwanted plants. Further, to enhance the efficiency of applying herbicidal active ingredients, it is highly desirable to combine two or more active ingredients in a single formulation. Compositions containing a combination of active ingredients with different modes of action can provide for greater control of unwanted plants and are beneficial for avoiding or reducing mixing errors when preparing the application mixture in the field. However, the release properties of herbicidal compositions of microencapsulated acetamide herbicides can be sensitive to the inclusion of further additives including co-herbicides. Accordingly, there remains a need for herbicidal compositions containing microencapsulated acetamide herbicides and co-herbicides that are stable over a wide range of conditions and that maintain the controlled release properties of the microencapsulated acetamide herbicide while providing longer weed control, increased crop safety, better compatibility with other tank mixed or premixed formulants, higher loading and improved physio-chemical stability. Additional benefits of co-encapsulation include simplified manufacturing process of making premix comprising multiple active ingredients utilizing a suitable single microencapsulation technology and reduced organic solvent usage.

With regard to herbicides, the emergence of certain herbicide resistant weeds has generated interest in developing strategies to supplement the action of primary herbicides such as glyphosate. Acetamide herbicides are known as effective residual control herbicides that reduce early season weed competition. In particular, acetamide herbicides such as acetochlor provide outstanding residual control of many grasses and broadleaf weeds including pigweed, waterhemp, lambsquarters, nightshade, foxtails, among others. Acetamides are generally classified as seedling growth inhibitors. Seedling growth inhibitors are absorbed and translocated in plants from germination to emergence primarily by subsurface emerging shoots and/or seedling roots. Acetamide herbicides typically do not offer significant post-emergence activity, but as a residual herbicide provide control of newly emerging monocots and small-seeded dicot weed species. This supplements the activity of post-emergent herbicides that lack significant residual activity.

Crop injury caused by application of acetanilide herbicides necessitated strategies to reduce this effect. One strategy involved applying the acetanilide herbicide formulations after the emergence of the crop (i.e., post-emergent to the crop), but before the emergence of later germinating weeds (i.e., pre-emergent to the weeds). However, application during this time window may cause foliar injury to the crop. Other strategies to reduce crop injury involved microencapsulating the acetanilide herbicide. Methods for producing microencapsulated acetanilides are described in various patents and publications.

Acetamide herbicides can be microencapsulated. Methods for producing microencapsulated acetamides are described in various documents including U.S. Pat. No. 5,925,595, US 2004/0137031, US 2005/0277549, US 2010/0248963, US 2013/0029847, WO 2016/112116, WO 2018/231913 and WO 2019/143455. Generally, to form microcapsules, the herbicide is encapsulated in a polymeric shell wall material. The herbicide is released from the microcapsules at least in part by molecular diffusion through the shell wall. Several factors including the type of herbicide, type of polymer, shell thickness, shell porosity, particle size, and presence of safeners can impact the rate of release of the herbicide from the microcapsules and/or crop safety associated with the microcapsules.

Acetochlor (2-chloro-N-(ethoxymethyl)-N-(2-ethyl-6-methylphenyl)acetamide) is a known haloacetanilide herbicide (U.S. Pat. No. 3,442,945) and is often abbreviated as ACC.

Diflufenican (N-(2,4-difluorophenyl)-2-[3-(trifluoromethyl)phenoxy]-3-pyridinecarboxamide) is a known herbicide (U.S. Pat. No. 4,618,366) and is often abbreviated as DFF.

Metribuzin (4-amino-6-(1,1-dimethylethyl)-3-(methylthio)-1,2,4-triazin-5(4H)-one) has been described in DE1795784 and U.S. Pat. No. 3,905,801 and is often abbreviated as MRB.

Mesotrione (2-[4-(methylsulfonyl)-2-nitrobenzoyl]cyclohexane-1,3-dione) is a known herbicide (U.S. Pat. No. 5,006,158) and is often abbreviated as MST.

US 2012/0129694 concerns herbicidal capsule suspensions of acetochlor, optionally comprising a safener.

IL181558 and WO 2006/029736 disclose certain liquid formulations comprising diflufenican in dissolved form, a certain type of solvent and a surfactant. US 2005/026786 relates to oil suspension concentrates containing diflufenican and a hydrocarbon solvent.

U.S. Pat. No. 5,741,756 and WO 01/43550 disclose certain mixtures of acetochlor and mesotrione, optionally with further herbicides.

CN 109874790 A pertains to microcapsule suspensions comprising acetochlor and mesotrione.

WO 97/27748 relates to stable herbicidal compositions containing metal chelates of herbicidal dione compounds like mesotrione.

U.S. Pat. No. 6,541,422 discloses a method for improving the selectivity of mesotrione in crops such as wheat by applying a metal chelate of mesotrione, optionally as microcapsule.

Diflufenican is an inhibitor of phytoene desaturase, blocking carotenoid biosynthesis, has a melting point of about 160° C. and a water solubility of about 50 μg/L (25° C.). As a consequence, diflufenican is difficult to be encapsulated by itself, but is an ideal molecule to be formulated as water-based suspension concentrates (SC formulations) and is difficult to be encapsulated by itself. Generally high loaded formulations are preferred in order to save costs in packaging and transportation which is a further challenge since high loaded SC formulations tend to get too viscous or form sticky sediments which cannot be easily redispersed.

In addition, controlled release formulations are desirable to reduce the risk of phytotoxicity caused by diflufenican when used in certain crops, for example in soybean.

WO 2018/231913 concerns microcapsules with a polyurea shell having a core comprising an acetamide herbicide and a second herbicide like metribuzin. WO 2020/021082 discloses capsules having controlled release properties comprising active ingredients like diflufenican. WO 2020/025566 teaches capsule suspensions with polyurea-capsules containing diflufenican.

### SUMMARY

This section provides a general summary of the disclosure, and is not a comprehensive disclosure of its full scope or all of its features.

Typically, organic solvents are needed to dissolve herbicidal active ingredients, so they can be microencapsulated using interfacial polymerization. It now was found that diflufenican can fully or partially dissolve in acetamide herbicides such as acetochlor thus allowing co-encapsulation of multiple active ingredients using microencapsulation technology.

It was found that diflufenican can be microencapsulated with acetamide herbicide(s) such as acetochlor in which diflufenican may be dissolved to a certain extent. In addition, certain organic non-polar solvents such as aromatic hydrocarbons and fatty acid dimethylamides (see details below) were found to further improve dissolution of diflufenican in acetamide herbicide(s) such as acetochlor such that the amount of diflufenican that is microencapsulated is further increased. Overall, not only a high load of acetamide herbicide in the microcapsules is achievable, but at the same time a higher loading of diflufenican therein making it possible to achieve a targeted field usage rate ratio, such as 1260 g/ha of acetochlor and 150 g/ha of diflufenican, in the core of the microcapsules together with the acetamide herbicide(s) such as acetochlor and the one or more organic non-polar solvents.

Among the several features of the disclosure, it may be noted that the microcapsules and herbicidal compositions of the present disclosure are useful in agriculture wherein multiple active ingredients are co-formulated at desirable loading to achieve optimal release rates of the herbicidal active ingredients, increased stability, higher weed control and/or increased bioavailability for active ingredients of low solubility.

Briefly, aspects of the present disclosure are directed to microcapsules comprising a) a polymeric shell wall, and b) a water-immiscible core material comprising (i) an acetamide herbicide, (ii) diflufenican, and (iii) an organic non-polar solvent, wherein the total weight of the acetamide herbicide and diflufenican comprises at least about 5 wt. % of the microcapsule. The microcapsules may further comprise a Photosystem II inhibitor, preferably metribuzin. In order to inter alia achieve the desired release properties of the (i) acetamide herbicide and (ii) diflufenican, the microcapsules of the present disclosure are characterized as having a mean particle size range of from about 2 μm to about 15 μm, from about 2 μm to about 12 μm, from about 2 μm to about 10 μm, from about 2 μm to about 8 μm, from about 3 μm to about 15 μm, from about 3 μm to about 10 μm, from about 3 μm to about 8 μm, from about 4 μm to about 15 μm, from about 4 μm to about 12 μm, from about 4 μm to about 10 μm, from about 4 μm to about 8 μm, or from about 4 μm to about 7 μm.

Other aspects of the present disclosure are directed to herbicidal composition comprising the microcapsule and further comprising an aqueous continuous phase.

Further aspects of the present disclosure are directed to methods for controlling weeds in a field of a crop plant, the method comprising applying to the field an application mixture comprising the aqueous herbicidal composition.

Other objects and features will be in part apparent and in part pointed out hereinafter. The description and specific examples in this summary are intended for purposes of illustration only and are not intended to limit the scope of the present disclosure.

### DETAILED DESCRIPTION

Example embodiments will now be described more fully. The description and specific examples included herein are intended for purposes of illustration only and are not intended to limit the scope of the present disclosure.

Generally, the present disclosure relates to microcapsules containing a core comprising (i) an acetamide herbicide, (ii) diflufenican and (iii) an organic non-polar solvent, optionally further comprising one or more further co-herbicide(s) and/or herbicide safeners. The present disclosure also relates to herbicidal compositions comprising these microcapsules, methods for preparing these microcapsules and herbicidal compositions and methods of using these compositions for controlling weeds. In particular, the disclosure primarily relates to a microcapsule comprising: a polymeric shell wall, and a water-immiscible core material comprising an (i) acetamide herbicide, (ii) diflufenican, and (iii) an organic non-polar solvent wherein the total weight of the acetamide herbicide and diflufenican comprises at least about 5 wt. % of the microcapsule, and preferably these active ingredients in a certain ratio by weight. Various embodiments are directed to microcapsules comprising acetamide-containing microcapsules dispersed in an aqueous liquid medium. Further embodiments are directed to application mixtures prepared from the concentration compositions and methods of using these compositions for controlling weeds.

### Microencapsulation

As noted, microcapsules of the present disclosure comprise a core material comprising the acetamide and a shell wall containing the core material. The process of microencapsulation can be conducted according to known interfacial polycondensation techniques. Microencapsulation of water-immiscible materials utilizing an interfacial polycondensation reaction generally involves dissolving a first reactive monomeric or polymeric material(s) (first shell wall component) in the material to be encapsulated to form the oil or discontinuous phase liquid. The discontinuous phase liquid is then dispersed into an aqueous or continuous phase liquid to form an oil-in-water emulsion. The continuous phase (aqueous) liquid may contain a second reactive monomeric or polymeric material (second shell wall component) at the time the discontinuous phase is dispersed into the continuous phase. If this is the case, the first and second shell wall components will immediately begin to react at the oil-in-water interface to form a polycondensate shell wall around the material to be encapsulated. However, the oil-in-water emulsion can also be formed before the second shell wall component is added to the emulsion.

### Polymeric Shell Wall

In one aspect, the polymeric shell wall comprises or consists of organic polymers, preferably selected from the group consisting of polyurea, polyurethane, polycarbonate, polyamide, polyester and polysulfonamide, and mixtures thereof.

In the following, features, properties and characteristics of preferred microcapsules according to the present disclosure are described, in particular microcapsules wherein the polymeric shell wall is a polyurea shell wall. of the microcapsules according to the present disclosure. These microcapsules are preferred for the reasons detailed herein in the context of the present disclosure.

Microcapsules according to the present disclosure wherein the polymeric shell wall is a polyurea shell wall are preferably formed in a polymerization medium by a polymerization reaction between a polyisocyanate component comprising a polyisocyanate or mixture of polyisocyanates and a polyamine component comprising a polyamine or mixture of polyamines to form the polyurea.

In a preferred microcapsule according to the present disclosure the polyisocyanate component comprises an aliphatic polyisocyanate.

In a preferred microcapsule according to the present disclosure the polyamine component comprises a polyamine of the structure NH₂(CH₂CH₂NH)ₘCH₂CH₂NH₂ where m is from 1 to 5, 1 to 3, or 2.

In a preferred microcapsule according to the present disclosure the polyamine component is selected from the group consisting of substituted or unsubstituted polyethyleneamine, polypropyleneamine, diethylene triamine, triethylenetetramine (TETA), and combinations thereof, preferably the polyamine component is triethylenetetramine (TETA).

In a preferred microcapsule according to the present disclosure the ratio of amine molar equivalents contained in the polyamine component to isocyanate molar equivalents contained in the polyisocyanate component is at least about 0.9:1, at least about 0.95:1, at least about 1:1, at least about 1.01:1, at least about 1.05:1, or at least about 1.1:1.

In a preferred microcapsule according to the present disclosure the polyurea shell wall is formed in a polymerization medium by a polymerization reaction between a polyisocyanate component comprising a polyisocyanate or mixture of polyisocyanates and a polyamine component comprising a polyamine or mixture of polyamines to form the polyurea and the ratio of amine molar equivalents contained in the polyamine component to isocyanate molar equivalents contained in the polyisocyanate component is from about from 1.01:1 to about 1.3:1, preferably from 1.01:1 to about 1.25:1, from 1.01:1 to about 1.2:1, from about 1.05:1 to about 1.3:1, from about 1.05:1 to about 1.25:1, from about 1.05:1 to about 1.2:1, from about 1.1:1 to about 1.3:1, from about 1.1:1 to about 1.25:1, and from about 1.1:1 to about 1.2:1.

The water-immiscible core material of the microcapsules of the present disclosure comprising the acetamide herbicide together with diflufenican is encapsulated with a polymeric shell wall, preferably a polyurea shell wall. In general, the polyurea shell wall is formed in a polymerization medium by a polymerization reaction between a polyisocyanate component comprising a polyisocyanate or mixture of polyisocyanates and a polyamine component comprising a polyamine or mixture of polyamines to form the polyurea. See, for example, U.S. Pat. No. 5,925,595, US 2004/0137031, US 2005/0277549, US 2010/0248963, US 2013/0029847, WO 2016/112116, WO 2018/231913 and WO 2019/143455.

The polyurea shell wall of the microcapsules of the present disclosure can be prepared by contacting an aqueous continuous phase containing a polyamine component comprising a polyamine source and a discontinuous oil phase containing the acetamide herbicide and diflufenican and a polyisocyanate component comprising a polyisocyanate source. A polyurea shell wall is formed in a polymerization reaction between the polyamine source and the isocyanate source at the oil/water interface thereby forming a microcapsule containing the acetamide herbicide and diflufenican.

The polyurea polymer shell wall of the microcapsules may be formed using one or more polyisocyanates, i.e., having two or more isocyanate groups per molecule. A wide variety of polyisocyanates can be employed. For example, the polyisocyanate component can comprise an aliphatic polyisocyanate (e.g., DESMODUR W, DESMODUR N 3200 and DESMODUR N 3215). In some embodiments, the polyurea shell wall is formed using a blend of at least two polyisocyanates. For example, the polyurea shell wall is formed in an interfacial polymerization reaction using at least one diisocyanate and at least one triisocyanate (e.g., a combination of DESMODUR W and DESMODUR N 3200 or N 3215).

The polyamine source can be a single polyamine species or a mixture of two or more different polyamine species. In some embodiments of the present disclosure, the polyamine source consists essentially of a principal polyamine. As used herein, a principal polyamine refers to a polyamine consisting essentially of a single polyamine species.

It is advantageous to select a polyamine component and a polyisocyanate component such that the polyamine has an amine functionality of at least 2, i.e., 3, 4, 5 or more, and at least one of the polyisocyanates has an isocyanate functionality of at least 2, i.e., 2.5, 3, 4, 5, or more since high amine and isocyanate functionality increases the percentage of cross-linking occurring between individual polyurea polymers that comprise the shell wall. In some embodiments, the polyamine has an amine functionality of greater than 2 and the polyisocyanate is a mixture of polyisocyanates wherein each polyisocyanate has an isocyanate functionality of greater than 2. In other embodiments, the polyamine comprises a trifunctional polyamine and the polyisocyanate component comprises one or more trifunctional polyisocyanates. In yet other embodiments, the shell wall is formed by the reaction between a polyisocyanate or mixture of polyisocyanates with a minimum average of 2.5 reactive groups per molecule and a polyamine with an average of at least three reactive groups per molecule. It is, moreover, advantageous to select concentrations of the polyamine component and the polyisocyanate component such that the polyisocyanate component is substantially completely reacted to form the polyurea polymer. Complete reaction of the polyisocyanate component increases the percentage of cross-linking between polyurea polymers formed in the reaction thereby providing structural stability to the shell wall.

As described, the oil-in-water emulsion that is formed during the interfacial polymerization reaction can be prepared by adding the oil phase to the continuous aqueous phase to which an emulsifying agent (emulsifier) has been added (e.g., previously dissolved therein). The emulsifying agent is selected to achieve the desired oil droplet size in the emulsion. The size of the oil droplets in the emulsion is influenced by a number of factors in addition to the emulsifying agent employed and determines the size of microcapsules formed by the process. The emulsifying agent is preferably a protective colloid. Polymeric dispersants are preferred as protective colloids. Polymeric dispersants provide steric stabilization to an emulsion by adsorbing to the surface of an oil drop and forming a high viscosity layer which prevents drops from coalescing. Polymeric dispersants may be surfactants and are preferred to surfactants which are not polymeric, because polymeric compounds form a stronger interfacial film around the oil drops. If the protective colloid is ionic, the layer formed around each oil drop will also serve to electrostatically prevent drops from coalescing.

Preferred emulsifying agents in the context of the present disclosure are lignin sulfonates, e.g. REAX® 105M=Highly sulfonated, low molecular weight sodium salt of kraft lignosulfonate dispersant with a low free electrolyte content (available from Ingevity), maleic acid-olefin copolymers, e.g. SOKALAN (available from BASF), and naphthalene sulfonate condensates, e.g. INVALON (available from Huntsman) and AGNIQUE NSC 11NP (available from BASF).

Further, it is preferred to add glycerin in the aqueous (i.e. external) phase to balance the density difference between the microcapsules and the continuous aqueous phase in which these capsules are suspended, making the formulation physically stable. Further, glycerin is an anti-freezing agent, thereby preventing formulations becoming frozen at low temperatures. Glycerin dissolves in water and is not included in the microcapsules obtained.

In various embodiments, the microencapsulation method includes encapsulating core material in a shell wall formed by reacting a polyamine component and a polyisocyanate component in a reaction medium in concentrations such that the reaction medium comprises a molar equivalent excess of amine groups compared to the isocyanate groups. That is, the molar equivalents ratio of amine equivalents to isocyanate equivalents used in preparation of the shell wall of the microcapsules is equal to or greater than about 1:1. For example, a molar equivalents ratio at least 1.01:1, or at least about 1.05:1, or at least about 1.1:1 is used to ensure that the isocyanate is completely reacted. The ratio of amine molar equivalents contained in the polyamine component to isocyanate molar equivalents contained in the polyisocyanate component can be from 1.01:1 to about 1.3:1, preferably from 1.01:1 to about 1.25:1, from 1.01:1 to about 1.2:1, from about 1.05:1 to about 1.3:1, from about 1.05:1 to about 1.25:1, from about 1.05:1 to about 1.2:1, from about 1.1:1 to about 1.3:1, from about 1.1:1 to about 1.25:1, and from about 1.1:1 to about 1.2:1.

The molar equivalents ratio of amine molar equivalents to isocyanate molar equivalents is calculated according to the following equation:

$$Molar Equivalents Ratio = \frac{amine molar equivalents}{isocyanate molar equivalents} \qquad ( 1 )$$

In the above equation (1), the amine molar equivalents is calculated according to the following equation (2):

molar equivalents=Σ(polyamine weight/equivalent weight) (2)

In the above equation (1), the isocyanate molar equivalents is calculated according to the following equation (3):

isocyanate molar equivalents=Σ(polyisocyanate weight/equivalent weight) (3)

The equivalent weight is generally calculated by dividing the molecular weight in grams/mole by the number of functional groups per molecules and is in grams/mole. For some molecules, such as triethylenetetramine (“TETA”) and 4,4′-diisocyanato-dicyclohexyl methane (“DES W”), the equivalent weight is equal to the molecular weight divided by the number of functional groups per molecule. For example, TETA has a molecular weight of 146.23 g/mole and 4 amine groups. Therefore, the equivalent weight is 36.6 g/mol. This calculation is generally correct, but for some materials, the actual equivalent weight may vary from the calculated equivalent weight. In some components, for example, the biuret-containing adduct (i.e., trimer) of hexamethylene-1,6-diisocyanate, the equivalent weight of the commercially available material differs from the theoretical equivalent weight due to, for example, incomplete reaction. The theoretical equivalent weight of the biuret-containing adduct (i.e., trimer) of hexamethylene-1,6-diisocyanate is 159.5 g/mol. The actual equivalent weight of the trimer of hexamethylene-1,6-diisocyanate (“DES N3200”), the commercially available product, is about 183 g/mol. This actual equivalent weight is used in the calculations above. The actual equivalent weight may be obtained from the manufacturer or by titration with a suitable reactant by methods known in the art. The symbol, Σ, in the amine molar equivalents calculation means that the amine molar equivalents comprises the sum of amine molar equivalents for all polyamines in the reaction medium. Likewise, the symbol, Σ, in the isocyanate molar equivalents calculation means that the isocyanate molar equivalents comprises the sum of isocyanate molar equivalents for all polyisocyanates in the reaction medium.

In general, the water-immiscible core material of the microcapsules is encapsulated by a polyurea shell wall, which is preferably substantially non-microporous, such that core material release occurs by a molecular diffusion mechanism, as opposed to a flow mechanism through a pore or rift in the polyurea shell wall. As noted herein, the shell wall may preferably comprise a polyurea product of a polymerization of one or more polyisocyanates and a principal polyamine (and optional auxiliary polyamine).

Generally, the microcapsules can be characterized as having a mean particle size of at least about 2, 3, 4, 5, 6, 7, 8, 9 or 10 μm. For example, the microcapsules have a mean particle size range of from about 2 μm to about 15 μm, from about 2 μm to about 12 μm, from about 2 μm to about 10 μm, from about 2 μm to about 8 μm, from about 3 μm to about 15 μm, from about 3 μm to about 10 μm, from about 3 μm to about 8 μm, from about 4 μm to about 15 μm, from about 4 μm to about 12 μm, from about 4 μm to about 10 μm, from about 4 μm to about 8 μm, or from about 4 μm to about 7 μm. Preferably, microcapsules are characterized as having a mean particle size range of from about 3 μm to about 9 μm. The microcapsules are essentially spherical such that the mean transverse dimension defined by any point on a surface of the microcapsule to a point on the opposite side of the microcapsule is essentially the diameter of the microcapsule. The mean particle size of the microcapsules can be determined by measuring the particle size of a representative sample with a laser light scattering particle size analyzer known to those skilled in the art. One example of a particle size analyzer is a Coulter LS Particle Size Analyzer.

As reported in US 2010/0248963, it is believed, without being bound to any particular theory, that the combination of increased mean particle size and the shell characteristics resulting from a large excess of unreacted amine groups significantly reduces the release rate. In the case of a herbicide core material, this combination of characteristics reduces the amount of herbicide that crop plants are exposed to following application, thereby providing enhanced crop safety and minimized crop plant injury. It is believed, without being bound to any particular theory, that increased excess of amine groups results in a significant number of unreacted amine functional groups thereby providing a shell having a large number of amine functional groups that are not cross-linked. It is believed that the resulting shell wall is flexible and resistant to rupturing such that the amount of herbicide that crop plants are initially exposed to upon application of a herbicidal formulation containing the microcapsules is reduced. It is further believed that unreacted amine groups may reduce the number of fissures or cracks in the shell wall thereby reducing leakage and flow of herbicide through the shell wall from the core.

The microcapsules of the disclosure may be obtained by a process comprising at least the steps of: Dissolving solid diflufenican and optionally a Photosystem II inhibitor (preferably metribuzin) in an acetamide herbicide (preferably acetochlor) which is mixed with one or more organic non-polar solvents at elevated temperature such as 65° C. to form a liquid, followed by forming an oil-in-water emulsion comprising a functional ingredient-containing core oil droplet dispersed in an aqueous phase, and reacting at least one polyisocyanate in the oil phase and at least one polyamine in aqueous phase to form a polyurea shell around said droplet to form a core-shell microcapsule. Preferred emulsifiers used in the aqueous phase (external phase) to form the oil-in-water emulsions are lignin sulfonate (salts), maleic acid-olefin copolymers or naphthalene sulfonate condensates.

In a further aspect, the present disclosure concerns a method of making a microcapsule of the present disclosure wherein the microcapsule is a polyurea core-shell microcapsule, including the steps of: (a) Preparing a liquid mixture by dissolving diflufenican, and optionally a further herbicide, preferably metribuzin, in a mixture comprising or consisting of acetamide herbicide(s), preferably acetochlor, and an organic non-polar solvent or mixture of organic non-polar solvents at a temperature in the range of from about 50 to 75° C., preferably at about 65° C.; (b) Adding a polyisocyanate component, preferably comprising or consisting of one or more aliphatic polyisocyanate components, into the liquid mixture of step (a); (c) Preparing an emulsifier-containing aqueous solution, wherein the total amount of emulsifiers is in the range of from about 0.5 to about 5% by weight; (d) Heating the emulsifier-containing aqueous solution of step (c) to a temperature in the range of from about 50 to 75° C., preferably to a temperature of about 65° C.; (e) Adding the liquid mixture resulting from step (b) into the heated emulsifier-containing aqueous solution of step (d), under mixing; (f) Adding a polyamine component, preferably comprising or consisting of one or more polyamine components selected from the group consisting of substituted or unsubstituted polyethyleneamine, polypropyleneamine, diethylene triamine, triethylenetetramine (TETA), and combinations thereof, into the emulsion resulting from step (e) under agitation and keeping the emulsion at a temperature in the range of from about 50 to 75° C., preferably at about 65° C., for about 30 minutes to about 120 minutes, preferably for about 60 minutes; (g) Cooling the mixture resulting from step (f), preferably to a temperature in the range of 10 to 35° C., typically to room temperature (about 25° C.).

In a preferred method of making a microcapsule according to the present disclosure the ratio of amine molar equivalents contained in the polyamine component to isocyanate molar equivalents contained in the polyisocyanate component is from about 1:01 to about 1.2:1.

### Active Ingredients of the Water-Immiscible Core Material of the Microcapsule

The microcapsules according to the present disclosure comprise a water-immiscible core material comprising at least two different herbicidal active ingredients, namely (i) an acetamide herbicide and (ii) diflufenican. In addition, other herbicidal active ingredients, like metribuzin, and/or safeners, can be incorporated into and be part of the water-immiscible core material of the microcapsules according to the present disclosure.

In a microcapsule according to the present disclosure the total weight of (i) acetamide herbicide and (i) diflufenican preferably is at least about 10 wt. %, more preferably at least about 15 wt. %, even more preferably at least about 20 wt. %, even more preferably at least about 25 wt. %, and particularly preferably at least about 30 wt. %, in each case based on the total weight of the microcapsule.

In a microcapsule according to the present disclosure the ratio by weight of the total amount of (i) acetamide herbicide to the total amount of (ii) diflufenican preferably is in the range of from about 3:1 to about 15:1, more preferably of from about 4:1 to about 12:1, even more preferably in the range of from about 6:1 to about 10:1, and particularly preferably in the range of from about 7:1 to about 9:1.

In a microcapsule according to the present disclosure the ratio by weight of the total amount of (i) acetamide herbicide to the total amount of (ii) diflufenican is in the range of from about 3:1 to about 20:1, preferably of from about 4:1 to about 18:1, more preferably in the range of from about 6:1 to about 18:1, even more preferably in the range of from about 7:1 to about 17:1.

In a preferred microcapsule according to the present disclosure the total weight of (i) acetamide herbicide and (i) diflufenican is 15 wt. % or more and the ratio by weight of the total amount of (i) acetamide herbicide to the total amount of (ii) diflufenican is in the range of from about 4:1 to about 12:1, in each case based on the total weight of the microcapsule.

In a more preferred microcapsule according to the present disclosure the total weight of (i) acetamide herbicide and (i) diflufenican is 20 wt. % or more and the ratio by weight of the total amount of (i) acetamide herbicide to the total amount of (ii) diflufenican is in the range of from about 6:1 to about 10:1, in each case based on the total weight of the microcapsule.

In an even more preferred microcapsule according to the present disclosure the total weight of (i) acetamide herbicide and (i) diflufenican is 25 wt. % or more and the ratio by weight of the total amount of (i) acetamide herbicide to the total amount of (ii) diflufenican is in the range of from about 6:1 to about 10:1, in each case based on the total weight of the microcapsule.

In an even more preferred microcapsule according to the present disclosure the total weight of (i) acetamide herbicide and (i) diflufenican is 30 wt. % or more and the ratio by weight of the total amount of (i) acetamide herbicide to the total amount of (ii) diflufenican is in the range of from about 6:1 to about 10:1, in each case based on the total weight of the microcapsule.

In a particularly preferred microcapsule according to the present disclosure the total weight of (i) acetamide herbicide and (i) diflufenican is 25 wt. % or more and the ratio by weight of the total amount of (i) acetamide herbicide to the total amount of (ii) diflufenican is in the range of from about 7:1 to about 9:1, in each case based on the total weight of the microcapsule.

In a particularly preferred microcapsule according to the present disclosure the total weight of (i) acetamide herbicide and (i) diflufenican is 30 wt. % or more and the ratio by weight of the total amount of (i) acetamide herbicide to the total amount of (ii) diflufenican is in the range of from about 7:1 to about 9:1, in each case based on the total weight of the microcapsule.

In a preferred microcapsule according to the present disclosure the total weight of (i) acetamide herbicide and (i) diflufenican is 15 wt. % or more and the ratio by weight of the total amount of (i) acetamide herbicide to the total amount of (ii) diflufenican is in the range of from about 3:1 to about 20:1, in each case based on the total weight of the microcapsule.

In a more preferred microcapsule according to the present disclosure the total weight of (i) acetamide herbicide and (i) diflufenican is 20 wt. % or more and the ratio by weight of the total amount of (i) acetamide herbicide to the total amount of (ii) diflufenican is in the range of from about 4:1 to about 18:1, in each case based on the total weight of the microcapsule.

In an even more preferred microcapsule according to the present disclosure the total weight of (i) acetamide herbicide and (i) diflufenican is 25 wt. % or more and the ratio by weight of the total amount of (i) acetamide herbicide to the total amount of (ii) diflufenican is in the range of from about 4:1 to about 18:1, in each case based on the total weight of the microcapsule.

In an even more preferred microcapsule according to the present disclosure the total weight of (i) acetamide herbicide and (i) diflufenican is 30 wt. % or more and the ratio by weight of the total amount of (i) acetamide herbicide to the total amount of (ii) diflufenican is in the range of from about 6:1 to about 18:1, in each case based on the total weight of the microcapsule.

In a particularly preferred microcapsule according to the present disclosure the total weight of (i) acetamide herbicide and (i) diflufenican is 25 wt. % or more and the ratio by weight of the total amount of (i) acetamide herbicide to the total amount of (ii) diflufenican is in the range of from about 7:1 to about 17:1, in each case based on the total weight of the microcapsule.

In a particularly preferred microcapsule according to the present disclosure the total weight of (i) acetamide herbicide and (i) diflufenican is 30 wt. % or more and the ratio by weight of the total amount of (i) acetamide herbicide to the total amount of (ii) diflufenican is in the range of from about 7:1 to about 17:1, in each case based on the total weight of the microcapsule.

The acetamide herbicide present in the water-immiscible core material of the microcapsules according to the present disclosure preferably comprises at least one herbicide selected from the group consisting of acetochlor, alachlor, butachlor, butenachlor, delachlor, diethatyl and agriculturally acceptable esters thereof, dimethachlor, dimethenamid, dimethenamid-P, mefenacet, metazachlor, metolachlor, S-metolachlor, napropamide, pretilachlor, pronamide, propachlor, propisochlor, prynachlor, terbuchlor, thenylchlor and xylachlor, or agriculturally acceptable esters thereof, and combinations thereof.

In various embodiments, the acetamide herbicide is selected from the group consisting of acetochlor, alachlor, metolachlor, S-metolachlor, dimethenamid, dimethenamid-P, butachlor, and combinations thereof.

In certain embodiments, the acetamide herbicide is selected from the group consisting of acetochlor, metolachlor and S-metolachlor. In some embodiments, the acetamide herbicide comprises or consists of acetochlor.

In a preferred microcapsule of the present disclosure, the total weight of the (i) acetamide herbicide is from about 10 wt. % to about 15 wt. %, from about 15 wt. % to about 20 wt. %, from about 20 wt. % to about 25 wt. %, from about 25 wt. % to about 30 wt. %, from about 30 wt. % to about 35 wt. %, from about 35 wt. % to about 40 wt. %, or from about 40 wt. % to about 45 wt. % of the microcapsule.

In a preferred microcapsule according to the present disclosure the total weight of the (i) acetamide herbicide, preferably of acetochlor, is in the range of from about 10 wt. % to about 50 wt. %, from about 10 wt. % to about 45 wt. %, from about 15 wt. % to about 45 wt. %, from about 15 wt. % to about 40 wt. %, from about 20 wt. % to about 40 wt. %, from about 25 wt. % to about 40 wt. %, or from about 30 wt. % to about 40 wt. % of the microcapsule.

In a preferred microcapsule according to the present disclosure the total weight of the (i) acetamide herbicide is at least about 20 wt. %, at least about 25 wt. %, or at least about 30 wt. % of the microcapsule.

In a preferred microcapsule according to the present disclosure the total weight of (ii) diflufenican is from about 2.0 wt. % to about 2.5 wt. %, from about 2.5 wt. % to about 3.0 wt. %, from about 3.0 wt. % to about 3.5 wt. %, from about 3.5 wt. % to about 4.0 wt. %, from about 4.0 wt. % to about 4.5 wt. %, or from about 4.5 wt. % to about 5.0 wt. % of the microcapsule.

In a preferred microcapsule according to the present disclosure the total weight of (ii) diflufenican is in the range of from about 2.0 wt. % to about 6.0 wt. %, from about 2.5 wt. % to about 5.5 wt. %, from about 2.5 wt. % to about 5.0 wt. %, from about 2.5 wt. % to about 4.5 wt. %, from about 3.0 wt. % to about 4.5 wt. % of the microcapsule.

In a preferred microcapsule according to the present disclosure the total weight of (ii) diflufenican is in the range of from about 1.0 wt. % to about 6.0 wt. %, from about 1.25 wt. % to about 5.0 wt. %, from about 1.25 wt. % to about 4.5 wt. %, from about 1.5 wt. % to about 4.0 wt. %, from about 1.5 wt. % to about 3.0 wt. % of the microcapsule.

In a preferred microcapsule according to the present disclosure the total weight of (ii) diflufenican is at least about 2.0 wt. %, or at least about 3.0 wt. % of the microcapsule.

In a preferred microcapsule according to the present disclosure the total weight of (ii) diflufenican is at least about 1.0 wt. %, or at least about 1.5 wt. % of the microcapsule.

In certain embodiments, the water-immiscible core material of the microcapsules according to the present disclosure comprises one or more further herbicides (i.e. different from the (i) acetamide herbicides and (ii) diflufenican)), preferably a Photosystem II inhibitor herbicide selected from the group consisting of ametryn, amicarbazone, atrazine, bentazon, bromacil, bromoxynil, chlorotoluron, cyanazine, desmedipham, desmetryn, dimefuron, diuron, fluometuron, hexazinone, ioxynil, isoproturon, linuron, metamitron, methibenzuron, metoxuron, metribuzin, monolinuron, phenmedipham, prometon, prometryn, propanil, pyrazon, pyridate, siduron, simazine, simetryn, tebuthiuron, terbacil, terbumeton, terbuthylazine and trietazine, and combinations thereof. More preferably, the water-immiscible core material of the microcapsules according to the present disclosure comprises the Photosystem II inhibitor herbicide metribuzin as further herbicide.

In a preferred microcapsule according to the present disclosure the total weight of the Photosystem II inhibitors, preferably of metribuzin, is at least about 4.5 wt. %, at least about 5.0 wt. %, or at least about 5.5 wt. % of the microcapsule.

In a preferred microcapsule according to the present disclosure the total weight of the Photosystem II inhibitors, preferably of metribuzin, is from about 4.5 wt. % to about 5.0 wt. %, from about 5.0 wt. % to about 5.5 wt. %, from about 5.5 wt. % to about 6.0 wt. %, from about 6.0 wt. % to about 6.5 wt. %, from about 6.5 wt. % to about 7.0 wt. %, or from about 7.0 wt. % to about 7.5 wt. % of the microcapsule.

In a preferred microcapsule according to the present disclosure the total weight of metribuzin is in the range of from about 4.0 wt. % to about 8.0 wt. %, from about 4.5 wt. % to about 7.5 wt. %, from about 5.0 wt. % to about 7.5 wt. %, from about 5.5 wt. % to about 7.5 wt. % of the microcapsule.

In a more preferred microcapsule according to the present disclosure the total weight of the microencapsulated herbicides is from about 15 wt. % to about 20 wt. %, from about 20 wt. % to about 25 wt. %, from about 25 wt. % to about 30 wt. %, from about 30 wt. % to about 35 wt. %, from about 35 wt. % to about 40 wt. %, from about 40 wt. % to about 45 wt. %, from about 45 wt. % to about 50 wt. %, or from about 50 wt. % to 55 wt. % of the microcapsule.

Other herbicidal active ingredients and/or safeners, that can be incorporated into and be part of the water-immiscible core material of the microcapsules according to the present disclosure are mentioned hereinafter.

In a preferred microcapsule according to the present disclosure the total weight of the microencapsulated herbicides is in the range of from about 15 wt. % to about 60 wt. % of the microcapsule, preferably from about 20 wt. % to about 60 wt. %, from about 25 wt. % to about 55 wt. %, from about 30 wt. % to about 55 wt. %., from about 35 wt. % to about 55 wt. %.

In a preferred microcapsule according to the present disclosure the water-immiscible core material further comprises a herbicide safener, preferably selected from the group consisting of benoxacor, cloquintocet-methyl, cloquintocet-mexyl, cyprosulfamide, fenchlorazole-ethyl, furilazole, isoxadifen-ethyl and mefenpyr-diethyl.

### Organic Non-Polar Solvents as Part of the Water-Immiscible Core Material of the Microcapsules:

One or more organic non-polar solvents are present as constituent (iii) in the core of the microcapsule according to the present disclosure to further increase the solubility of (ii) diflufenican in the core material as well as to change the solubility parameter characteristics of the core material to increase or decrease the release rate of the active ingredients (e.g. (i) acetochlor, (ii) diflufenican and optionally metribuzin) from the microcapsule, once release has been initiated. For example, the core material may comprise from 0.1% to about 35% by weight of a non-polar organic solvent, for example from 0.1 to about 25% by weight, from about 0.5% and about 20% by weight, or from about 1% and 10% by weight. In particular, the core material may comprise 0%, 0.5% 1%, 2%, 3%, 4%, 5%, 6%, 7%, 8%, 10%, 15%, 20%, 25%, 30% or even 35% organic non-polar solvents. In some embodiments, the organic non-polar solvent is a water-insoluble organic solvent having a solubility in water of less than 5, 1, 0.5 or even 0.1 gram per liter at 25° C.

Also, the ratio of weight of core material components compared to weight of shell wall components can be adjusted to further affect the release rate profile of the herbicidal active ingredients out of the microcapsules.

In a preferred microcapsule according to the present disclosure the ratio by weight of the total weight of the (i) acetamide herbicide to the total weight of the (iii) organic non-polar solvents in said microcapsule is in the range of from in the range of from 3:2 to 20:1, preferably 3:2 to 15:1, more preferably in the range of from 5:3 to 12:1, even more preferably in the range of from 2:1 to 10:1.

In a preferred microcapsule according to the present disclosure the total weight of the (i) acetamide herbicide and the (iii) organic non-polar solvents is at least about 25 wt. % of the microcapsule, preferably at least about 30 wt. %, more preferably at least about 35 wt. %, more preferably at least about 40 wt. %.

In a more preferred microcapsule according to the present disclosure the total weight of the (iii) organic non-polar solvent is at least about 5 wt. %, at least about 6 wt. %, at least about 7 wt. %, at least about 8 wt. %, at least about 9 wt. %, or at least about 10 wt. % of the microcapsule.

In a more preferred microcapsule according to the present disclosure the total weight of the (iii) organic non-polar solvent is from about 5 wt. % to about 8 wt. %, from about 8 wt. % to about 11 wt. %, from about 11 wt. % to about 14 wt. %, from about 14 wt. % to about 17 wt. %, or from about 17 wt. % to about 20 wt. % of the microcapsule.

In a preferred microcapsule according to the present disclosure the total weight of the (iii) organic non-polar solvent is in the range of from about 5 wt. % to about 25 wt. %, from about 5 wt. % to about 20 wt. %, from about 8 wt. % to about 20 wt. %, from about 11 wt. % to about 17 wt. % of the microcapsule.

Constituent (ii) diflufenican should be sufficiently miscible or soluble in a mixture of constituent (i) the one or more acetamide herbicides, preferably acetochlor, and constituent (iii) the one or more organic non-polar solvents forming (part of) the internal phase when producing the microcapsules according to the present disclosure. If this is not the case, problems in the manufacturing process of the microcapsules may occur, e.g. deformed microcapsules and/or microcapsules with an inhomogeneous core (e.g. not being essentially free of crystals of DFF or containing DFF crystals substantially different in size) are obtained, overall making it more difficult to achieve uniform and reliable release properties of the active ingredients, e.g. (i) acetochlor and (ii) diflufenican (and optionally metribuzin) from the microcapsules.

It was found that certain types of organic non-polar solvents, for example linear, branched or cyclic paraffinic hydrocarbons, are less suitable as (part of) constituent (iii) the one or more organic non-polar solvents of the microcapsules of the present disclosure than other organic non-polar solvents. Thus, although organic non-polar solvents such as paraffinic hydrocarbons are in principle suitable organic non-polar solvents as (part of) constituent (iii) to form the internal phase and be part of water-immiscible core material of microcapsules according to the present disclosure, they are less preferred than other organic non-polar solvents.

Preferred organic non-polar solvents used to form the internal phase and be part of water-immiscible core material of microcapsules according to the present disclosure are organic non-polar solvents selected from the group consisting of aromatic hydrocarbons, e.g. toluene, xylene, tetrahydronaphthalene, alkylated naphthalenes, fatty acid dimethylamides, and fatty acid esters, and mixtures thereof. Fatty acids in the context of the present disclosure are C6-C18 fatty acids (i.e. fatty acids with 6 to 18 carbon atoms), preferably C8-C12 fatty acids (i.e. fatty acids with 8 to 12 carbon atoms).

In a preferred microcapsule according to the present disclosure the (iii) organic non-polar solvent comprises or consists of aromatic hydrocarbons, fatty acid dimethylamides, fatty acid esters, and mixtures thereof.

It was further found that aromatic hydrocarbon solvents and fatty acid dimethylamides are particularly suitable organic solvents for (forming the internal phase of the) microcapsules according to the present disclosure,

Preference is given to aromatic hydrocarbons with 10 to 16 carbon atoms (C10-C16), preferably aromatic hydrocarbons with a distillation range 232-278° C. (like Aromatic 200 or Aromatic 200 ND from ExxonMobil). Aromatic 200 ND [Solvent Naphtha (petroleum), Heavy Aromatic], is a complex mixture of aromatic hydrocarbons, the main components thereof (typically about 50-85 wt.-%) are aromatic hydrocarbons (C11-C14) including 1-methylnaphthalene and 2-methylnaphthalene, as well as aromatic hydrocarbons (C10), including naphthalene, and aromatic hydrocarbons (C15-C16), the total amount of aromatic hydrocarbons being >99 wt.-%.

In another more preferred embodiment fatty acid dimethylamides are used as organic solvent, such as the blend of N,N-dimethyloctanamide and N,N-dimethyldecanamide (with the brand name of Armid DM 810 from AkzoNobel or Steposol M-8-10 from Stepan).

Therefore, in a more preferred microcapsule according to the present disclosure the (iii) organic non-polar solvent comprises or consist of one or more aromatic hydrocarbons, preferably one or more aromatic hydrocarbons C10-C16.

Also, in a more preferred microcapsule according to the present disclosure the (iii) organic non-polar solvent comprises or consists of N,N-dimethyloctanamide, N,N-dimethyldecanamide and mixtures thereof.

### Further Pesticides and Safeners Optionally Present in the Microcapsules or the Herbicidal Compositions of the Present Disclosure

The microcapsules of the present disclosure and the herbicidal compositions of the present disclosure can comprise further pesticides and/or safeners. Depending on the solubility properties of the further pesticides and/or safeners optionally used, the further pesticides and/or safeners may be incorporated into the core of the microcapsules of the present disclosure in case they are water-insoluble or water-immiscible, or the further pesticides and/or safeners may be incorporated into the (typically aqueous) medium comprising the dispersed microcapsules of the present disclosure and be dissolved or dispersed therein in case the further pesticides and/or safeners are water-soluble or water-miscible.

Further pesticides and safeners optionally incorporated into microcapsules of the present disclosure or into the herbicidal compositions of the present disclosure and the common names used herein are known in the art, see, for example, “The Pesticide Manual” 16^{th} Edition, British Crop Protection Council 2012; these include the known stereoisomers (in particular racemic and enantiomeric pure isomers) and derivatives such as salts or esters, and particularly the commercially customary forms. Where a pesticide, in particular an herbicide, is referenced generically herein by name, unless otherwise restricted, that pesticide includes all commercially available forms known in the art such as salts, esters, free acids and free bases, as well as stereoisomers thereof. For example, where the herbicide name “glyphosate” is used, glyphosate acid, salts and esters are within the scope thereof.

The further pesticides preferably comprise or are further herbicides. In these and other embodiments, the one or more further herbicides can be selected from the group consisting of acetyl CoA carboxylase (ACCase) inhibitors, enolpyruvyl shikimate-3-phosphate synthase (EPSPS) inhibitors, glutamine synthetase inhibitors, auxins, photosystem I (PS I) inhibitors, photosystem II (PS II) inhibitors, acetolactate synthase (ALS) or acetohydroxy acid synthase (AHAS) inhibitors, mitosis inhibitors, protoporphyrinogen oxidase (PPO) inhibitors, 4-Hydroxyphenylpyruvate dioxygenase (HPPD) inhibitors, cellulose inhibitors, oxidative phosphorylation uncouplers, dihydropteroate synthase inhibitors, fatty acid and lipid biosynthesis inhibitors, auxin transport inhibitors and carotenoid biosynthesis inhibitors, salts and esters thereof, racemic mixtures and resolved isomers thereof, and mixtures thereof.

Safeners in the context of the present disclosure are herbicide safeners. Preferably, safeners are selected from the group consisting of benoxacor, cloquintocet and agriculturally acceptable esters thereof, cyometrinil, cyprosulfamide, dichlormid, dicyclonon, dietholate, fenchlorazole and agriculturally acceptable esters thereof, fenclorim, flurazole, fluxofenim, furilazole, isoxadifen and agriculturally acceptable esters thereof, mefenpyr and agriculturally acceptable esters thereof, mephenate, metcamifen, naphthalic anhydride, oxabetrinil, and mixtures thereof. More preferably, the herbicide safener is selected from the group consisting of benoxacor, cloquintocet-methyl, cloquintocet-mexyl, cyprosulfamide, fenchlorazole-ethyl, furilazole, isoxadifen-ethyl and mefenpyr-diethyl.

EPSPS herbicides include glyphosate or a salt or ester thereof.

Glutamine synthetase herbicides include glufosinate or glufosinate-P, or a salt or and ester thereof.

ACCase inhibitors include, for example, alloxydim, butroxydim, clethodim, cycloxydim, pinoxaden, sethoxydim, tepraloxydim and tralkoxydim, salts and esters thereof, and mixtures thereof. Another group of ACCase inhibitors include chlorazifop, clodinafop, clofop, cyhalofop, diclofop, diclofop-methyl, fenoxaprop, fenthiaprop, fluazifop, haloxyfop, isoxapyrifop, metamifop, propaquizafop, quizalofop and trifop, salts and esters thereof, and mixtures thereof. ACCase inhibitors also include mixtures of one or more “dims” and one or more “fops”, salts and esters thereof.

Auxin herbicides (i.e., synthetic auxin herbicides) include, for example, 2,4-dichlorophenoxyacetic acid (2,4-D), 4-(2,4-dichlorophenoxy)butyric acid (2,4-DB), dichloroprop, 2-methyl-4-chlorophenoxyacetic acid (MCPA), 4-(4-chloro-2-methylphenoxy)butanoic acid (MCPB), aminopyralid, clopyralid, fluroxypyr, triclopyr, diclopyr, mecoprop, dicamba, picloram, quinclorac, benazolin, halauxifen, fluorpyrauxifen, methyl 4-amino-3-chloro-5-fluoro-6-(7-fluoro-1H-indol-6-yl)pyridine-2-carboxylate, 4-amino-3-chloro-5-fluoro-6-(7-fluoro-1H-indol-6-yl)pyridine-2-carboxylic acid, benzyl 4-amino-3-chloro-5-fluoro-6-(7-fluoro-1H-indol-6-yl)pyridine-2-carboxylate, methyl 4-amino-3-chloro-5-fluoro-6-(7-fluoro-1-isobutyryl-1H-indol-6-yl)pyridine-2-carboxylate, methyl 4-amino-3-chloro-6-[1-(2,2-dimethylpropanoyl)-7-fluoro-1H-indol-6-yl]-5-fluoropyridine-2-carboxylate, methyl 4-amino-3-chloro-5-fluoro-6-[7-fluoro-1-(methoxyacetyl)-1H-indol-6-yl]pyridine-2-carboxylate, methyl 6-(1-acetyl-7-fluoro-1H-indol-6-yl)-4-amino-3-chloro-5-fluoropyridine-2-carboxylate, potassium 4-amino-3-chloro-5-fluoro-6-(7-fluoro-1H-indol-6-yl)pyridine-2-carboxylate, and butyl 4-amino-3-chloro-5-fluoro-6-(7-fluoro-1H-indol-6-yl)pyridine-2-carboxylate, salts and esters thereof, and mixtures thereof.

PS II inhibitors that can be used in the context of the present disclosure in addition as further herbicides include, for example, ametryn, amicarbazone, atrazine, bentazon, bromacil, bromoxynil, chlorotoluron, cyanazine, desmedipham, desmetryn, dimefuron, diuron, fluometuron, hexazinone, ioxynil, isoproturon, linuron, metamitron, methibenzuron, metoxuron, metribuzin, monolinuron, phenmedipham, prometon, prometryn, propanil, pyrazon, pyridate, siduron, simazine, simetryn, tebuthiuron, terbacil, terbumeton, terbuthylazine and trietazine, salts and esters thereof, and mixtures thereof, metribuzin being the preferred PS II inhibitor in the context of the present disclosure.

ALS and AHAS inhibitors include, for example, amidosulfuron, azimsulfruon, bensulfuron-methyl, bispyribac-sodium, chlorimuron-ethyl, chlorsulfuron, cinosulfuron, cloransulam-methyl, cyclosulfamuron, diclosulam, ethametsulfuron-methyl, ethoxysulfuron, flazasulfuron, florazulam, flucarbazone, flucetosulfuron, flumetsulam, flupyrsulfuron-methyl, foramsulfuron, halosulfuron-methyl, imazamethabenz, imazamox, imazapic, imazapyr, imazaquin, imazethapyr, imazosulfuron, iodosulfuron, metsulfuron-methyl, nicosulfuron, penoxsulam, primisulfuron-methyl, propoxycarbazone-sodium, prosulfuron, pyrazosulfuron-ethyl, pyribenzoxim, pyrithiobac, rimsulfuron, sulfometuron-methyl, sulfosulfuron, thiencarbazone, thifensulfuron-methyl, triasulfuron, tribenuron-methyl, trifloxysulfuron and triflusulfuron-methyl, salts and esters thereof, and mixtures thereof.

Mitosis inhibitors include anilofos, benefin, DCPA, dithiopyr, ethalfluralin, flufenacet, mefenacet, oryzalin, pendimethalin, thiazopyr and trifluralin, salts and esters thereof, and mixtures thereof.

PPO inhibitors include, for example, acifluorfen, azafenidin, bifenox, butafenacil, carfentrazone-ethyl, epyrifenacil, flufenpyr-ethyl, flumiclorac, flumiclorac-pentyl, flumioxazin, fluoroglycofen, fluthiacet-methyl, fomesafen, lactofen, oxadiargyl, oxadiazon, oxyfluorfen, pyraflufen-ethyl, saflufenacil and sulfentrazone, salts and esters thereof, and mixtures thereof.

4-Hydroxyphenylpyruvate dioxygenase (HPPD) inhibitors and Carotenoid biosynthesis inhibitors that can be used in the context of the present disclosure—in addition to (ii) diflufenican comprised in the microcapsules of the present disclosure—as further herbicides include, for example, aclonifen, amitrole, beflubutamid, benzofenap, clomazone, fluridone, flurochloridone, flurtamone, isoxaflutole, mesotrione, norflurazon, picolinafen, pyrasulfotole, pyrazolynate, pyrazoxyfen, sulcotrione, tefuryltrione, tembotrione, tolpyralate and topramezone, salts and esters thereof, and mixtures thereof.

In certain embodiments, mesotrione is present in the herbicidal compositions of the present disclosure. If present, mesotrione preferably is present in the water phase of the herbicidal compositions of the present disclosure. If present, mesotrione preferably is present in the herbicidal compositions of the present disclosure in at least partially chelated form, and preferably chelated by divalent transition metal ions, preferably by Cu²⁺, Co²⁺, Ni²⁺ or Zn²⁺ metal ions. If mesotrione is present in chelated form, particularly preferably the transition metal ions are divalent copper ions (Cu²⁺). In such a case, the divalent copper ions (Cu²⁺) forming the mesotrione chelate are preferably used in the form of Cu(II)sulfate such as Copper sulfate pentahydrate CuSO₄.5H₂O.

If present, the total weight of mesotrione on an acid equivalent (ae) basis is from about 1.0 wt. % to about 5.0 wt. %, preferably from about 1.5 wt. % to about 4.5 wt. %, more preferably from about 1.75 wt. % to about 4.0 wt. %, even more preferably from about 2.0 wt. % to about 3.5 wt. %, in each case based on the total weight of the herbicidal composition.

If present, mesotrione typically is present in the herbicidal compositions of this disclosure in solid form, wherein preferably the solid particles have an average particle size of from about 2 μm to about 12 μm, preferably of from about 3 μm to about 10 μm, more preferably of from about 4 μm to about 9 μm, particularly preferably of from about 5 μm to about 8 μm.

The incorporation of mesotrione or a metal chelate thereof into the herbicidal compositions of the present disclosure may be accomplished using methods known in the art, for example as described in WO 97/27748.

According to one process useful in the context of the present disclosure, the mesotrione is milled and then added to the aqueous phase of a mixture having microcapsules of the present disclosure suspended in the aqueous phase. Subsequently, an aqueous solution of an appropriate salt of the divalent transition metal ions may be added to said mixture to allow to react at room temperature for a period of time sufficient to convert mesotrione to its corresponding divalent transition metal chelate. The pH-value of the resulting mixture typically is then adjusted a pH-value in the range of about 3 to about 7, using an appropriate acid.

According to another process useful in the context of the present disclosure, the mesotrione need not be milled prior to formation of the divalent transition metal chelate. In this process, the mesotrione is added to the aqueous phase of a mixture having microcapsules of the present disclosure suspended therein. The pH-value of the resultant mixture is then adjusted to about 10, using sodium hydroxide or another base. An aqueous solution of an appropriate divalent transition metal salt may then added to the mixture with stirring and crystals of the divalent transition metal chelate of mesotrione form instantly. If a divalent transition metal salt is added, the reaction is allowed to proceed until mesotrione is converted to its corresponding divalent transition metal chelate. Finally, the pH-value of the resulting mixture typically is adjusted a pH-value in the range of about 3 to about 7, using an appropriate acid, such as hydrochloric acid.

PS I inhibitors include diquat and paraquat, salts and esters thereof, and mixtures thereof.

Cellulose inhibitors include dichlobenil and isoxaben.

An oxidative phosphorylation uncoupler is dinoterb, and esters thereof.

Auxin transport inhibitors include diflufenzopyr and naptalam, salts and esters thereof, and mixtures thereof.

Fatty acid and lipid biosynthesis inhibitors include bensulide, butylate, cycloate, EPTC, esprocarb, molinate, pebulate, prosulfocarb, thiobencarb, triallate and vernolate, salts and esters thereof, and mixtures thereof.

The acidic herbicide can comprise an auxin herbicide selected from the group consisting of 2,4-D, 2,4-DB, dichloroprop, MCPA, MCPB, aminopyralid, clopyralid, fluroxypyr, triclopyr, diclopyr, mecoprop, dicamba, picloram and quinclorac, salts and esters thereof, and mixtures thereof. In various embodiments, the acidic further herbicide comprises a salt of dicamba such as an alkali metal salt or amine salt of dicamba. Specific examples of salts of dicamba include the sodium salt of dicamba, the potassium salt of dicamba, the monoethanolamine salt of dicamba, the diglycolamine salt of dicamba, the dimethylamine salt of dicamba and combinations thereof.

In these and other embodiments, the acidic further herbicide comprises a salt of 2,4-D (e.g., an alkali metal or amine salt). In certain embodiments, the acidic further herbicide comprises at least one herbicide selected from the group consisting glyphosate, fomesafen, glufosinate, dicamba, and salts thereof, and combinations thereof.

### Herbicidal Compositions Comprising the Microcapsules

The herbicidal compositions of the present disclosure comprise microcapsules according to the present disclosure and may preferably be further formulated with additives as described elsewhere herein (e.g., a stabilizer, one or more surfactants, an antifreeze, an anti-packing agent, drift control agents, etc.).

The herbicidal compositions of the present disclosure containing the microcapsules of the present disclosure can be formulated to further optimize its shelf stability and safe use. Dispersants, stabilizers, and thickeners are useful to inhibit the agglomeration and settling of the microcapsules. This function is facilitated by the chemical structure of these additives as well as by equalizing the densities of the aqueous and microcapsule phases. Anti-packing agents are useful when the microcapsules are to be redispersed. A pH buffer can be used to maintain the pH of the dispersion in a range which is safe for skin contact and, depending upon the additives selected, in a narrower pH range than may be required for the stability of the dispersion.

Low molecular weight dispersants may solubilize microcapsule shell walls, particularly in the early stages of their formation, causing gelling problems. Thus, in some embodiments dispersants having relatively high molecular weights of at least about 1.5 kg/mole, more preferably of at least about 3 kg/mole, and still more preferably at least about 5, 10 or even 15 kg/mole. In some embodiments, the molecular weight may range from about 3 kg/mole to about 50 kg/mole or from about 5 kg/mole to about 50 kg/mole. Dispersants may also be non-ionic or anionic. An example of a high molecular weight, anionic polymeric dispersant is polymeric naphthalene sulfonate sodium salt, such as Invalon (formerly Irgasol, Huntsman Chemicals). Other useful dispersants and stabilizers include gelatin, casein, ammonium caseinate, polyvinyl alcohol, alkylated polyvinyl pyrrolidone polymers, maleic anhydride-methyl vinyl ether copolymers, styrene-maleic anhydride copolymers, maleic acid-butadiene and diisobutylene copolymers, ethylene oxide-propylene oxide block copolymers, sodium and calcium lignosulfonates, sulfonated naphthalene-formaldehyde condensates, modified starches, and modified cellulosics like hydroxyethyl or hydroxypropyl cellulose, sodium carboxy methyl cellulose, and fumed silica dispersions.

Thickeners are useful in retarding the settling process by increasing the viscosity of the aqueous phase. Shear-thinning thickeners may be preferred, because they act to reduce dispersion viscosity during pumping, which facilitates the economical application and even coverage of the dispersion to an agricultural field using the equipment commonly employed for such purpose. The viscosity of the microcapsule dispersion upon formulation may preferably range from about 100 cps to about 400 cps, as tested with a Haake Rotovisco Viscometer and measured at about 10° C. by a spindle rotating at about 45 rpm. More preferably, the viscosity may range from about 100 cps to about 300 cps. A few examples of useful shear-thinning thickeners include water-soluble, guar- or xanthan-based gums (e.g. Kelzan from CPKelco), cellulose ethers (e.g. ETHOCEL from Dow), modified cellulosics and polymers (e.g. Aqualon thickeners from Hercules), and microcrystalline cellulose anti-packing agents.

Adjusting the density of the aqueous phase to approach the mean weight per volume of the microcapsules also slows down the settling process. In addition to their primary purpose, many additives may increase the density of the aqueous phase. Further increase may be achieved by the addition of sodium chloride, glycol, urea, or other salts. The weight to volume ratio of microcapsules of preferred dimensions is approximated by the density of the core material, where the density of the core material is from about 1.05 to about 1.5 g/cm³. Preferably, the density of the aqueous phase is formulated to within about 0.2 g/cm³ of the mean weight to volume ratio of the microcapsules. More preferably, the density of the aqueous phase ranges from about 0.2 g/cm³ less than the mean weight to volume ratio of the microcapsules to about equal to the mean weight to volume ratio of the microcapsules.

In order to enhance shelf stability and prevent gelling of aqueous dispersions of microcapsules, particularly upon storage in high temperature environments, the microcapsule dispersions may further include urea or similar structure-breaking agent at a concentration of up to about 20% by weight, typically about 5% by weight.

Surfactants can optionally be included in the herbicide compositions of the present disclosure. Suitable surfactants are selected from non-ionics, cationic s, anionics, zwitterionics and mixtures thereof. Examples of surfactants suitable for the practice of the present disclosure include, but are not limited to: alkoxylated tertiary etheramines (such as TOMAH E-Series surfactants), alkoxylated quaternary etheramine (such as TOMAH Q-Series surfactant), alkoxylated etheramine oxides (such as TOMAH AO-Series surfactant), alkoxylated tertiary amine oxides (such as AROMOX series surfactants), alkoxylated tertiary amine surfactants (such as the ETHOMEEN T and C series surfactants), alkoxylated quaternary amines (such as the ETHOQUAD T and C series surfactants), alkyl sulfates, alkyl ether sulfates and alkyl aryl ether sulfates (such as the WITCOLATE series surfactants), alkyl sulfonates, alkyl ether sulfonates and alkyl aryl ether sulfonates (such as the WITCONATE series surfactants), lignin sulfonate (such as the REAX series) and alkoxylated phosphate esters and diesters (such as the PHOSPHOLAN series surfactants), alkyl polysaccharides (such as the AGRIMUL PG series surfactants), alkoxylated alcohols (such as the BRIJ or HETOXOL series surfactants), and mixtures thereof.

Anti-packing agents facilitate redispersion of microcapsules upon agitation of a formulation in which the microcapsules have settled. A microcrystalline cellulose material such as LATTICE from FMC is effective as an anti-packing agent. Other suitable anti-packing agents are, for example, clay, silicon dioxide, insoluble starch particles, and insoluble metal oxides (e.g. aluminum oxide or iron oxide). Anti-packing agents which change the pH of the dispersion are preferably avoided, for at least some embodiments.

Drift control agents suitable for the practice of the present disclosure are known to those skilled in the art and include the commercial products GARDIAN, GARDIAN PLUS, DRI-GARD, PRO-ONE XL ARRAY, COMPADRE, IN-PLACE, BRONC MAX EDT, EDT CONCENTRATE, COVERAGE and BRONC Plus Dry EDT.

The pH of the herbicide compositions may preferably range from about 4 to about 9, in order to minimize eye irritation of those persons who may come into contact with the formulation in the course of handling or application to crops. However, if components of a formulated dispersion are sensitive to pH, such as for example the blocking agent, buffers such as disodium phosphate may be used to hold the pH in a range within which the components are most effective. Additionally, a pH buffer such as citric acid monohydrate may be particularly useful in some systems during the preparation of the microcapsules, to maximize the effectiveness of a protective colloid such as SOKALAN® CP9.

Other useful additives include, for example, biocides or preservatives (e.g., PROXEL®, commercially available from Avecia), antifreeze agents (such as glycerol, sorbitol, or urea), and antifoam agents (such as Antifoam SE23 from Wacker Silicones Corp. or Agnique® DFM-111S, a silicone based defoamer).

The herbicide compositions described herein can in addition to the microcapsules of the present disclosure further comprise an additive to control or reduce potential herbicide volatility. Under some application conditions, certain herbicides such as auxin herbicides can, vaporize into the surrounding atmosphere and migrate from the application site to adjacent crop plants, such as soybeans and cotton, where contact damage to sensitive plants can occur. For example, as described in US2014/0128264 and US2015/0264924, which are incorporated herein by reference, additives to control or reduce potential pesticide volatility include monocarboxylic acids, or salts thereof, e.g., acetic acid and/or an agriculturally acceptable salt thereof.

Suitable alkali metal salts of the auxin herbicides include agriculturally acceptable alkali metal salts. For example, the alkali metal salts can include sodium and/or potassium. In various embodiments, the alkali metal salt comprises sodium (e.g., sodium dicamba, sodium 2,4-D, etc.). In some embodiments, the alkali metal salt comprises potassium (e.g., potassium dicamba, potassium 2,4-D, etc.).

In a further aspect, the present disclosure relates to a herbicidal composition comprising one or more microcapsules of the present disclosure.

The herbicidal composition of the present disclosure preferably is in the form of a concentrate or in the form of a diluted spray application mixture.

Preferably, the herbicidal composition of the present disclosure comprises an aqueous phase, preferably an aqueous continuous phase.

Preferably the microcapsules of the present disclosure are dispersed in the herbicidal composition of the present disclosure, preferably dispersed in the aqueous phase of herbicidal composition of the present disclosure.

Preferably, the herbicidal composition of the present disclosure comprises one or more further adjuvants, formulation auxiliaries or additives customary in crop protection.

Preferably, the herbicidal composition of the present disclosure comprises one or more further pesticides, preferably one or more further herbicides and/or one or more safeners.

Preferably, the herbicidal composition of the present disclosure, preferably the aqueous phase of the composition, preferably the aqueous continuous phase of the composition, further comprises one or more emulsifiers.

Preferably, the herbicidal composition of the present disclosure, preferably the aqueous phase of the composition, preferably the aqueous continuous phase of the composition, further comprises one or more formulation adjuvants, preferably selected from anti-freezing agents (such as urea, glycol and glycerin), substances for controlling microorganism growth (such as bactericides), and stabilizers to help physically stabilize the formulation and/or for controlling the formulation viscosity (such as natural or synthetic polymers such as Xanthan gum, guar gum, agar, carboxymethyl cellulose).

In a further aspect, the present disclosure relates to a method of making the herbicidal composition of the present disclosure in the form of a diluted spray application mixture, wherein the herbicidal composition in the form of a concentrate of the present disclosure is poured (slowly) into a water contained vessel under (mild) agitation.

Preferably, in said method of making the herbicidal composition of the present disclosure in the form of a diluted spray application mixture the amount of water used is such that the concentration of acetochlor in the resulting diluted spray application mixture is in the range of from about 0.7% to about 1.5% by weight, preferably in the range of from about 0.9% to about 1.3% by weight.

Preferably, in said method of making the herbicidal composition of the present disclosure in the form of a diluted spray application mixture the ratio by weight of water to concentrate is in the range of from about 1:50 to about 1:10, preferably in the range of from about 1:40 to about 1:15, more preferably in the range of from about 1:30 to about 1:20.

The diluted spray application mixture (application mixture) may be applied to a field according to practices known to those skilled in the art. In some embodiments, the application mixture is applied to the soil, before planting the crop plants or after planting, but pre-emergent to the crop plants. Because the herbicidal active release characteristics of microcapsules of the present disclosure are adjustable, the timing of release initiation (or increase release) can be controlled thereby giving both commercially acceptable weed control and a commercially acceptable rate of crop injury.

The effective amount of microcapsules according to the present disclosure and optional further herbicide(s) to be applied to an agricultural field is dependent upon the identity of the herbicides, the release rate of the microcapsules, the crop to be treated, and environmental conditions, especially soil type and moisture. Generally, application rates of acetamide herbicides, such as, for example, acetochlor, are on the order of about 0.1, 0.5, 1, 2, 3, 4, 5, 6, 7, 8, 9 or 10 kilograms of herbicide per hectare, or ranges thereof, such as from 0.5 to 10 kilograms per hectare, from 0.5 to 10 kilograms per hectare, from 0.5 to 5 kilograms per hectare, or from 1 to 5 kilograms per hectare. In some embodiments, an application rate for sorghum, rice and wheat of from about 0.85 to about 1 kilograms per hectare is preferred. In preferred embodiments, typical application rates are 1260 g/ha of acetochlor and 150 g/ha of diflufenican, or 630 g/ha of acetochlor and 75 g/ha of diflufenican.

Generally, application rates of optional co-herbicides, such as, for example, dicamba, are on the order of about 0.05, 0.1, 0.5, 1, 1.5, 2, 2.5, 3, 4 or 5 kilograms of herbicide per hectare, or ranges thereof, such as from 0.1 to 5 kilograms per hectare, from 0.5 to 2.5 kilograms per hectare, or from 0.5 to 2 kilograms per hectare.

Application mixtures of the aqueous herbicidal concentrates are preferably applied to an agricultural field within a selected timeframe of crop plant development. In various embodiments of the present disclosure, the application mixture prepared from an aqueous herbicidal concentrate is applied post-emergence to crop plants. For purposes of the present disclosure, post-emergence to crop plants includes initial emergence from the soil, i.e., “at cracking”. In some embodiments, the application mixture is applied to a field from 1-40 days prior to planting of the crop plant and/or pre-emergence (i.e., from planting of the crop plant up to, but not including, emergence or cracking) in order to provide control of newly emerging monocots and small seeded dicot species without significant crop damage. In various embodiments, the application mixture prepared from an aqueous herbicidal concentrate of the present disclosure is applied pre-emergence to weeds.

Application mixtures of the aqueous herbicidal concentrates of the present disclosure are useful for controlling a wide variety of weeds, i.e., plants that are considered to be a nuisance or a competitor of commercially important crop plants, such as corn, soybean, cotton, dry beans, snap beans, and potatoes etc. In some embodiments, the application mixtures are applied before the weeds emerge (i.e., pre-emergence application).

Monocotyledonous weeds belong, for example, to the genera Echinochloa, Setaria, Panicum, Digitaria, Phleum, Poa, Festuca, Eleusine, Brachiaria, Lolium, Bromus, Avena, Cyperus, Sorghum, Agropyron, Cynodon, Monochoria, Fimbristylis, Sagittaria, Eleocharis, Scirpus, Paspalum, Ischaemum, Sphenoclea, Dactyloctenium, Agrostis, Alopecurus and Apera.

Dicotyledonous weeds belong, for example, to the genera Sinapis, Lepidium, Galium, Stellaria, Matricaria, Anthemis, Galinsoga, Chenopodium, Urtica, Senecio, Amaranthus, Portulaca, Xanthium, Convolvulus, Ipomoea, Polygonum, Sesbania, Ambrosia, Kochia, Cirsium, Carduus, Sonchus, Solanum, Rorippa, Rotala, Lindernia, Lamium, Veronica, Abutilon, Emex, Datura, Viola, Galeopsis, Papaver, Centaurea, Trifolium, Ranunculus, Taraxacum and Euphorbia.

Examples of weeds that may be controlled according to the method of the present disclosure include, but are not limited to, Meadow Foxtail (Alopecurus pratensis) and other weed species with the Alopecurus genus, Common Barnyard Grass (Echinochloa crus-galli) and other weed species within the Echinochloa genus, crabgrasses within the genus Digitaria, White Clover (Trifolium repens), Lambsquarters (Chenopodium berlandieri), Redroot Pigweed (Amaranthus retroflexus) and other weed species within the Amaranthus genus, Proso millet (Panicum miliaceum) and other weed species of the Panicum spp., Common Purslane (Portulaca oleracea) and other weed species in the Portulaca genus, Chenopodium album and other Chenopodium spp., Setaria lutescens and other Setaria spp., Solanum nigrum and other Solanum spp., Lolium multiflorum and other Lolium spp., Brachiaria platyphylla and other Brachiaria spp., Sorghum halepense and other Sorghum spp., Conyza Canadensis and other Conyza spp., and Eleusine indica. In some embodiments, the weeds comprise one or more glyphosate-resistant species, 2,4-D-resistant species, dicamba-resistant species and/or ALS inhibitor herbicide-resistant species. In some embodiments, the glyphosate-resistant weed species is selected from the group consisting of Amaranthus palmeri, Amaranthus retroflexus, Amaranthus rudis, Amaranthus tamariscinus, Ambrosia artemisiifolia, Ambrosia trifida, Conyza bonariensis, Conyza canadensis, Digitaria insularis, Echinochloa colona, Eleusine indica, Euphorbia heterophylla, Lolium multiflorum, Lolium rigidum, Plantago lancelata, Sorghum halepense, Panicum miliaceum and Urochloa panicoides.

Certain crop plants such as soybean, cotton and corn are less susceptible to the action of acetamide herbicides and optional other co-herbicides such as dicamba than are weeds. In accordance with the present disclosure and based on experimental evidence to date, it is believed that the controlled acetamide release rate from the encapsulated acetamide herbicides in combination with crop plants having reduced acetamide susceptibility enables commercial control of weeds and commercially acceptable rates of crop damage when encapsulated acetamide herbicides are applied to a field either pre-planting or pre-emergent to the crop plant. This enables the use of seedling growth inhibitor acetamide herbicides, optionally seedling growth inhibitor acetamide herbicides in combination with a further herbicide such as dicamba, in crop plant pre-planting and pre-emergence applications.

In some embodiments of the present disclosure, crop plants include, for example, corn, soybean, cotton, dry beans, snap beans, and potatoes. Crop plants include hybrids, inbreds, and transgenic or genetically modified plants having specific traits or combinations of traits including, without limitation, herbicide tolerance (e.g., resistance to glyphosate, glufosinate, dicamba, sethoxydim, PPO inhibitor, etc.), Bacillus thuringiensis (Bt), high oil, high lysine, high starch, nutritional density, and drought resistance. In some embodiments, the crop plants are tolerant to organophosphorus herbicides, acetolactate synthase (ALS) or acetohydroxy acid synthase (AHAS) inhibitor herbicides, auxin herbicides and/or acetyl CoA carboxylase (ACCase) inhibitor herbicides. In other embodiments the crop plants are tolerant to glyphosate, dicamba, 2,4-D, MCPA, quizalofop, glufosinate and/or diclofop-methyl. In other embodiments, the crop plant is glyphosate and/or dicamba tolerant. In some embodiments of the present disclosure, crop plants are glyphosate and/or glufosinate tolerant. In some other embodiments, the crop plants are glyphosate, glufosinate and dicamba tolerant. In these or other embodiments, the crop plants are tolerant to PPO inhibitors.

Particularly preferred crop species are corn, cotton and soybean. In embodiments where the crop is corn, it is preferred to apply the application mixture at planting to before crop emergence, before planting of the crop (e.g., 1-4 weeks before planting crop), and/or after the crop has emerged. In embodiments where the crop is cotton, it is preferred to apply the application mixture at planting to before crop emergence, before planting of the crop (e.g., 1-4 weeks before planting crop), and/or after the crop has emerged (e.g., using a shielded sprayer to keep application mixture off of the crop). In embodiments where the crop is soybean, it is preferred to apply the application mixture at planting to before crop emergence, before planting of the crop (e.g., 1-4 weeks before planting crop), and/or after the crop has emerged.

Thus, the present disclosure also relates to a method for controlling undesired vegetation, in particular for controlling undesired vegetation in a field of a crop plant, the method comprising applying to the field a herbicidal composition of the present disclosure or a dilution thereof.

In the method for controlling undesired vegetation in a field of a crop plant, the crop plant preferably is selected from the group consisting of soybean, corn, canola, cotton, peanuts, potatoes, sugarbeets and/or wheat.

In the method for controlling undesired vegetation in a field of a crop plant, the crop plant preferably is soybean.

In the method for controlling undesired vegetation in a field of a crop plant, the crop plant preferably is corn.

In the method for controlling undesired vegetation, the application mixture preferably is applied to the field (i) prior to planting the crop plant or (ii) pre-emergence to the crop plant.

In the method for controlling undesired vegetation, the application mixture preferably is applied to the field post-emergence to the crop plant.

In the method for controlling undesired vegetation in a field of a crop plant, the crop plants have one or more herbicide tolerant traits.

The herbicidal compositions of the present disclosure or a dilution thereof were also found to be able to control difficult to control undesired vegetation (in a field of a crop plant).

The present disclosure therefore also relates to a method of applying to the field a herbicidal composition of the present disclosure or a dilution thereof, characterized in that it is carried out for difficult to control undesired vegetation (weeds or plants), in particular undesired vegetation (weeds or plants) having a resistance to one or more herbicides.

In another aspect, the method for controlling undesired vegetation is carried out for controlling weeds or plants having a resistance to herbicides of one, two, three, four, five or more different Modes of Action, wherein the resistances preferably are selected from the group consisting of auxin herbicide resistance, glyphosate resistance, acetolactate synthase (ALS) inhibitor resistance, 4-hydroxyphenylpyruvate dioxygenase (HPPD) inhibitor resistance, CoA carboxylase (ACCase) inhibitor resistance, photosystem I (PS I) inhibitor resistance, photosystem II (PS II) inhibitor resistance, protoporphyrinogen oxidase (PPO) inhibitor resistance, phytoene desaturase (PDS) inhibitor resistance and synthesis of very long-chain fatty acid (VLCFA) inhibitor resistance.

This applies particularly to undesired vegetation (weeds or plants) that are resistant to or are evolving resistance to one or to multiple Modes of Action, in particular resistance to one or more herbicides selected from the group consisting of glyphosate, auxin herbicides (auxins), ALS inhibitor herbicides, PSII inhibitor herbicides, HPPD inhibitor herbicides, PPO inhibitor herbicides and/or VLCFA inhibitor herbicides.

In one aspect, said method or use is carried out for controlling weeds or plants having a resistance to glyphosate.

In another aspect, said method or use is carried out for controlling weeds or plants having a resistance to glyphosate and one, two, three, four or more further resistances mentioned above, preferably selected from the group consisting of acetolactate synthase (ALS) inhibitor resistance, photosystem II (PS II) inhibitor resistance, 4-hydroxyphenylpyruvate dioxygenase (HPPD) inhibitor resistance, phytoene desaturase (PDS) inhibitor resistance and protoporphyrinogen oxidase (PPO) inhibitor resistance.

Examples of such resistant weeds include Amaranthus palmeri, Amaranthus tuberculatus, Kochia scoparia, Chenopodium album, Ambrosia trifida, Ambrosia artemisiifolia, Echinochloa crus-galli, Echinochloa colona, Lolium multiflorum and Eleusine indica.

In a further aspect, the present disclosure relates to a composition suitable to be used as water-immiscible core material for producing a microcapsule according to the present disclosure, wherein the composition comprises or consists of: (i) an acetamide herbicide, preferably an acetamide herbicide mentioned as preferred herein, more preferably acetochlor; (ii) diflufenican; and (iii) an organic non-polar solvent, preferably an organic non-polar solvent mentioned herein as preferred or more preferred; and optionally (iv) metribuzin.

### EXAMPLES

The following non-limiting examples are provided to further illustrate the present disclosure.

Unless indicated otherwise, all amounts and percentages are by weight.

### ABBREVIATIONS AND MATERIALS USED

1×=full rate, i.e. used at the full recommended rate

½×=0.5×=half rate, i.e. used at 50% of full recommended rate

¼×=quarter rate, i.e. used at 25% of full recommended rate

2×=twice the full rate, i.e. used at the double of the full recommended rate

ACC=Acetochlor

Agnique® DFM-111S=Silicone based defoamer

a.i. or ai=Active ingredient

Armid DM810=Mixture of N,N-dimethyl-octanamide and N,N-dimethyldecanamide (Nouryon Chemicals, formerly Akzo Nobel)

Aromatic 200=Mixture of aromatic hydrocarbons, Solvent Naphtha (Petroleum), Heavy Aromatic (ExxonMobil)

Conosol® C-170=Aliphatic solvent composed primarily of C10-C15 cycloparaffinic and isoparaffinic hydrocarbons (Calumet Lubricants)

DAT=Days After Treatment

Desmodur® N 3215=Aliphatic isocyanate based on hexamethylene diisocyanate (Covestro)

DFF=Diflufenican

Isopar™ M=Aliphatic solvent composed primarily of C11-C16 isoparaffinic hydrocarbons (isoalkanes), contains less than 2% of aromatics (ExxonMobil)

Kelzan® CC=Xanthan gum

MRB=Metribuzin

MST=Mesotrione

Norpar 15=Aliphatic solvent composed primarily of C14-C16 linear paraffinic hydrocarbons (n-alkanes), main constituent n-pentadecane (ExxonMobil)

Proxel®=Proxel® GXL=Solution of 1,2-benzisothiazolin-3-one (preservative)

REAX® 105M=Highly sulfonated, low molecular weight sodium salt of kraft lignosulfonate dispersant with a low free electrolyte content (Ingevity)

Sokalan® CP9=Maleic acid-olefin copolymer, 25% aqueous solutions (BASF)

TETA=Triethylenetetramine

Trt=Treatment

Brodal®=Commercial product (suspension concentrate) containing 500 g/L of diflufenican (Bayer)

Callisto®=Commercial product containing 40% of mesotrione (Syngenta)

TriCor® DF=Commercial product (granules) containing 75% of metribuzin (UPL)

Warrant®=Commercial product (capsule suspension) containing 33% of acetochlor (Bayer)

### Example 1: Method of Preparation for 2-Way and 3-Way Premix According to the Disclosure

An aqueous herbicidal composition was prepared according to the protocol described herein. The internal phase was prepared as shown in Tables 1A to 1E indicating the approximate weight percentage of each component in the final aqueous composition. To prepare the internal phase of the microcapsules, acetochlor was charged to the mixing vessel. Next, typically the organic non-polar solvent Aromatic 200 or Armid DM 810 was charged to the mixing vessel, followed by the Desmodur® N 3215 polyisocyanates and diflufenican solid powder and other active ingredients optionally included in the core material like metribuzin. The solution was agitated and heated to about 65° C. to obtain a clear homogenous solution. The solution may be sealed within the mixing vessel and stored until needed. Prior to use, the mixture was kept at 65° C. in an oven. The external aqueous phase was prepared containing the components and amounts shown. To prepare the external phase, a mixing vessel was charged with water and the remaining external phase components except TETA. The solution was agitated to obtain a clear homogenous solution. The solution may be sealed within the mixing vessel and stored until needed. Prior to use, the mixture was heated to 65° C. in oven. The interfacial polymerization medium was prepared by first charging the external phase (without TETA) to a Waring blender cup preheated to 65° C. The commercial Waring blender (Waring Products Division, Dynamics Corporation of America, New Hartford, Conn., Blender 700) was powered through a 0 to 120 Volt variable autotransformer. The blender mix speed was varied by controlling power to the blender. The internal phase was added to the external phase over a 16 second interval and blending was continued to obtain an emulsion. To initiate polymerization and encapsulation of the internal phase, TETA was added to the emulsion over a period of about 5 seconds. The blender speed is then reduced to produce a vortex for approximately five to fifteen minutes. During emulsification, the mixer speed was varied by controlling the blender to achieve mean particle sizes (Particle size) as shown in the Tables 1A to 1E. The emulsion was then transferred to a hot plate and stirred. The reaction vessel is covered and maintained at about 65° C. for approximately 1.5 hours. The resulting slurry is then allowed to cool to room temperature. The microcapsules of active ingredients were then mixed with premixed stabilizers as shown in the Tables 1A to 1E to form an aqueous dispersion. The stabilizer premix was prepared using a high-speed mixer (Waring Blender or Cowles Dissolver). The resulting stabilizer premix is then added to the slurry to stabilize the dispersion of microcapsules and the mixture is stirred for at least 15 minutes until visually homogeneous. The particle size may be measured with a laser light scattering particle size analyzer known to those skilled in the art. One example of a particle size analyzer is a Coulter LS Particle Size Analyzer. The microcapsules are essentially spherical such that the mean transverse dimension defined by any point on a surface of the microcapsule to a point on the opposite side of the microcapsule is essentially the diameter of the microcapsule.

Glycerin in the following examples is used in the External Phase to balance the density difference between the microcapsules and the continuous aqueous phase in which these capsules are suspended, making the formulation physically stable. Secondly, glycerin is an anti-freezing agent, thereby preventing formulations becoming frozen at low temperatures. Glycerin dissolves in water and is not included in the microcapsules obtained.

TABLE 1A
2-way premix with Acetochlor and Diflufenican

| | | | | | | | | |
|---|---|---|---|---|---|---|---|---|
| | 7406- | 7406- | 7406- | 7406- | 7406- | 7406- | | 7406- |
| Constituent | 2 | 3 | 4 | 7 | 8 | 9 | 7406-11 | 20 |

Internal Phase (wt. %)

| | | | | | | | | |
|---|---|---|---|---|---|---|---|---|
| ACC (96%) | 28.85 | 28.85 | 33.23 | 33.23 | 33.23 | 33.23 | 33.23 | 28.85 |
| DFF (93.4%) | 3.53 | 3.53 | 4.07 | 4.07 | 4.07 | 4.07 | 4.07 | 3.53 |
| Aromatic 200 | — | 11.58 | 6.68 | 6.68 | — | — | 6.68 | 11.58 |
| ARMID DM810 | 11.58 | — | — | — | 6.68 | 6.68 | — | — |
| Desmodur ^{®} N 3215 | 3.16 | 3.16 | 3.16 | 3.16 | 3.16 | 3.16 | 3.16 | 3.16 |

External Phase (wt. %)

| | | | | | | | | |
|---|---|---|---|---|---|---|---|---|
| Glycerin | 2.07 | 2.07 | 2.07 | 2.07 | 2.07 | 2.07 | 2.07 | 2.07 |
| Sokalan ^{®} CP9 (25%) | 4.19 | 4.19 | 4.19 | 4.19 | 4.19 | 4.19 | 4.19 | 3.00 |
| Water | 40.59 | 40.59 | 40.59 | 40.59 | 40.59 | 40.59 | 40.59 | 41.78 |
| TETA (50%) | 1.50 | 1.50 | 1.50 | 1.50 | 1.50 | 1.50 | 1.50 | 1.50 |

Stabilizer (wt. %)

| | | | | | | | | |
|---|---|---|---|---|---|---|---|---|
| Kelzan ^{®} CC (2%, | 4.51 | 4.51 | 4.51 | 4.51 | 4.51 | 4.51 | 4.51 | 4.51 |
| containing 0.4% | | | | | | | | |
| Proxel ^{®} | | | | | | | | |

Active ingredient content (wt. %)

| | | | | | | | | |
|---|---|---|---|---|---|---|---|---|
| ACC (%) | 27.70 | 27.70 | 31.90 | 31.90 | 31.90 | 31.90 | 31.90 | 27.72 |
| DFF (%) | 3.30 | 3.30 | 3.80 | 3.80 | 3.80 | 3.80 | 3.80 | 3.30 |
| ACC/DFF ratio | 8.40 | 8.40 | 8.40 | 8.40 | 8.40 | 8.40 | 8.40 | 8.40 |
| Total (%) | 31.00 | 31.00 | 35.70 | 35.70 | 35.70 | 35.70 | 35.70 | 31.02 |
| Particle size (μm) | 7.9 | 8.5 | 8.0 | 3.5 | 4.3 | 8.2 | 3.4 | 3.3 |

TABLE 1B
2-way premix with Acetochlor and Diflufenican

| | | | | | |
|---|---|---|---|---|---|
| Constituent | 7406-34 | 7406-45 | 7406-48 | 7406-49 | Ref1* |

Internal Phase (wt. %)

| | | | | | |
|---|---|---|---|---|---|
| ACC (96%) | 37.60 | 37.60 | 37.69 | 37.69 | 40.31 |
| DFF (93.4%) | 4.60 | 4.60 | 4.61 | 4.61 | 4.93 |
| Aromatic 200 | 7.52 | 7.52 | 7.54 | 7.54 | — |
| Desmodur ® | 3.57 | 3.57 | 2.56 | 2.56 | 2.73 |
| N 3215 | | | | | |

External Phase (wt. %)

| | | | | | |
|---|---|---|---|---|---|
| Glycerin | 2.35 | 2.35 | 2.35 | 2.35 | 2.52 |
| REAX ® 105M | 3.06 | 3.06 | 3.07 | 3.07 | 3.28 |
| Water | 36.98 | 36.98 | 37.06 | 37.06 | 37.73 |
| TETA (50%) | 1.70 | 1.70 | 1.23 | 1.23 | 1.31 |

Stabilizer (wt. %)

| | | | | | |
|---|---|---|---|---|---|
| Kelzan ® CC | 2.55 | 2.55 | 3.83 | 3.83 | 7.11 |
| (2%, containing | | | | | |
| 0.4% Proxel ®) | | | | | |
| Agnique ® DFM- | 0.05 | 0.05 | 0.05 | 0.05 | 0.05 |
| 111S | | | | | |
| Proxel ® GXL | 0.02 | 0.02 | 0.02 | 0.02 | 0.02 |

Active ingredient content (wt. %)

| | | | | | |
|---|---|---|---|---|---|
| ACC | 36.10 | 36.10 | 36.18 | 36.18 | 38.70 |
| DFF | 4.30 | 4.30 | 4.31 | 4.31 | 4.61 |
| ACC/DFF ratio | 8.40 | 8.40 | 8.40 | 8.40 | 8.40 |
| Total | 40.40 | 40.40 | 40.49 | 10.49 | 43.31 |
| Particle size (μm) | 3.7 | 7.1 | 3.5 | 4.3 | 3.5 |

Ref1*: Due to the absence of organic non-polar solvent(s), higher temperatures of up to 80° C. were necessary to allow microcapsule formation; crystallization of DFF was observed and deformed microcapsules were obtained.

Table 1B-1 depicts 2-way premixes with varying ratios for ACC and DFF such that for an acetochlor application rate of 1260 g/ha (1×), when the ACC/DFF ratio is 8.4, 150 g/ha DFF will be applied, when the ACC/DFF ratio is 12.6, 100 g/ha DFF will be applied and when the ACC/DFF is of 16.8, 75 g/ha DFF will be applied.

TABLE 1B-1
2-way premix with Acetochlor and Diflufenican

| | | | | | | |
|---|---|---|---|---|---|---|
| | 5875- | 5875- | 5875- | 5529- | 5529- | 7406- |
| Constituent | 2 | 3 | 4 | 75 | 100 | 45 |

Internal phase (wt %)

| | | | | | | |
|---|---|---|---|---|---|---|
| Acetochlor | 41.50 | 27.41 | 32.37 | 37.78 | 38.72 | 37.80 |
| (ACC) | | | | | | |
| Diflufenican | 3.30 | 3.26 | 2.57 | 2.25 | 3.08 | 4.50 |
| (DFF) | | | | | | |
| Aromatic | 5.79 | 15.7 | 12.4 | 7.87 | 7.75 | 7.52 |
| 200 | | | | | | |
| Desmodur | 3.15 | 2.932 | 2.682 | 3.05 | 3.04 | 3.57 |
| 3215N | | | | | | |

External phase (wt %)

| | | | | | | |
|---|---|---|---|---|---|---|
| Glycerin | 2.90 | 2.60 | 3.07 | 2.34 | 2.33 | 2.35 |
| REAX | 2.93 | 3.013 | 2.90 | 3.05 | 3.04 | 3.06 |
| 105M | | | | | | |
| (40%) | | | | | | |
| Water | 38.8 | 43.46 | 42.58 | 42.05 | 40.46 | 39.37 |
| TETA | 1.49 | 1.39 | 1.26 | 1.45 | 1.45 | 1.7 |
| (50%) | | | | | | |

Stabilizers (wt %)

| | | | | | | |
|---|---|---|---|---|---|---|
| Kelzan CC | 0.07 | 0.066 | 0.071 | 0.06 | 0.06 | 0.06 |
| Proxel GXL | 0.04 | 0.061 | 0.060 | 0.06 | 0.05 | 0.05 |
| Agnique | 0.02 | 0.030 | 0.028 | 0.04 | 0.02 | 0.02 |
| DFM-111S | | | | | | |
| Total | 100.0 | 100.0 | 100.0 | 100.0 | 100.0 | 100.0 |
| ACC/ | 12.6 | 8.4 | 12.6 | 16.8 | 12.6 | 8.4 |
| DFF ratio | | | | | | |

TABLE 1C
3-way premix with Acetochlor, Diflufenican and Metribuzin

| | | | | | | |
|---|---|---|---|---|---|---|
| | 7406- | 7406- | 7406- | 7406- | 7406- | 7406- |
| Constituent | 13 | 14 | 15 | 16 | 17 | 18 |

Internal Phase

| | | | | | | |
|---|---|---|---|---|---|---|
| ACC (96%) | 25.26 | 25.26 | 25.26 | 25.26 | 25.26 | 25.26 |
| DFF (93.4%) | 3.06 | 3.06 | 3.06 | 3.06 | 3.06 | 3.06 |
| MRB (97%) | 5.56 | 5.56 | 5.56 | 5.56 | 5.56 | 5.56 |
| Aromatic 200 | 10.10 | — | 10.10 | — | 10.10 | 10.10 |
| Armid DM810 | — | 10.10 | — | 10.10 | — | — |
| Desmodur ^{®} | 3.16 | 3.16 | 3.16 | 3.16 | 3.16 | 3.16 |
| N 3215 | | | | | | |

External Phase

| | | | | | | |
|---|---|---|---|---|---|---|
| Glycerin | 2.07 | 2.07 | 2.07 | 2.07 | 2.07 | 2.07 |
| Sokalan ^{®} | 4.19 | 4.19 | 4.19 | 4.19 | 4.19 | 4.19 |
| CP9 (25%) | | | | | | |
| Water | 40.59 | 40.59 | 40.59 | 40.59 | 40.59 | 40.59 |
| TETA (50%) | 1.50 | 1.50 | 1.50 | 1.50 | 1.50 | 1.50 |

Stabilizer

| | | | | | | |
|---|---|---|---|---|---|---|
| Kelzan ^{®} CC (2%, | 4.51 | 4.51 | 4.51 | 4.51 | 4.51 | 4.51 |
| containing 0.4% | | | | | | |
| Proxel ^{®}) | | | | | | |

Active ingredient content (wt. %)

| | | | | | | |
|---|---|---|---|---|---|---|
| ACC | 24.20 | 24.20 | 24.20 | 24.20 | 24.20 | 24.20 |
| DFF | 2.88 | 2.88 | 2.88 | 2.88 | 2.88 | 2.88 |
| ACC/DFF ratio | 8.40 | 8.40 | 8.40 | 8.40 | 8.40 | 8.40 |
| MRB | 5.38 | 5.38 | 5.38 | 5.38 | 5.38 | 5.38 |
| Total | 32.46 | 32.46 | 32.46 | 32.46 | 32.46 | 32.46 |
| Particle | 7.5 | 7.8 | 4.9 | 4.2 | 3.4 | 2.1 |
| size (μm) | | | | | | |

TABLE 1D
3-way premix with Acetochlor,
Diflufenican and Metribuzin

| | | |
|---|---|---|
| Constituent | 7406-31 | 7406-32 |

Internal Phase (wt. %)

| | | |
|---|---|---|
| ACC (95.6%) | 26.87 | 26.87 |
| DFF (93.4%) | 3.25 | 3.25 |
| MRB (97%) | 5.91 | 5.91 |
| Aromatic 200 | 10.75 | 10.75 |
| Desmodur ® 3215 | 3.36 | 3.36 |

External Phase (wt. %)

| | | |
|---|---|---|
| Glycerin | 2.21 | 2.21 |
| REAX ® 105M | 2.88 | 2.88 |
| (40%) | | |
| Water | 38.37 | 38.37 |
| TETA (50%) | 1.60 | 1.60 |

Stabilizer (wt. %)

| | | |
|---|---|---|
| Kelzan ® CC | 4.80 | 4.80 |
| (2%, containing | | |
| 0.4% Proxel ®) | | |

Active ingredient content (wt. %)

| | | |
|---|---|---|
| ACC | 25.69 | 25.69 |
| DFF | 3.04 | 3.04 |
| MRB | 5.74 | 5.74 |
| ACC/DFF ratio | 8.45 | 8.45 |
| Total | 34.47 | 34.47 |
| Particle size (μm) | 5.7 | 6.5 |

TABLE 1E
3-way premix with Acetochlor, Diflufenican and Metribuzin

| | | | | | | |
|---|---|---|---|---|---|---|
| | 7406- | 7406- | 7406- | 7406- | 7406- | 7406- |
| Constituent | 36 | 38 | 46 | 47 | 51 | 54 |

Internal Phase (wt. %)

| | | | | | | |
|---|---|---|---|---|---|---|
| ACC (95.90%) | 29.62 | 29.62 | 29.62 | 29.62 | 29.02 | 29.62 |
| DFF (93.4%) | 3.63 | 3.63 | 3.63 | 3.63 | 3.55 | 3.63 |
| MRB (97%) | 6.98 | 6.98 | 6.98 | 6.98 | 6.84 | 6.98 |
| Aromatic 200 | 8.89 | 8.89 | 8.89 | 8.89 | 8.71 | 8.89 |
| Desmodur ^{®} | 3.53 | 3.53 | 2.52 | 2.52 | 2.47 | 2.52 |
| N 3215 | | | | | | |

External Phase (wt. %)

| | | | | | | |
|---|---|---|---|---|---|---|
| Glycerin | 2.32 | 2.32 | 2.32 | 2.32 | 2.27 | 2.32 |
| REAX ^{®} 105M | | | | | | |
| (40%) | 3.02 | 3.02 | 3.03 | 3.03 | 2.96 | 3.03 |
| Water | 36.52 | 36.52 | 37.97 | 37.97 | 36.53 | 37.97 |
| TETA (50%) | 1.68 | 1.68 | 1.21 | 1.21 | 1.18 | 1.21 |
| Stabilizer (wt. %) | | | | | | |
| Kelzan ^{®} CC | 3.78 | 3.78 | 3.79 | 3.79 | 6.42 | 3.79 |
| (2%, containing | | | | | | |
| 0.4% Proxel ^{®}) | | | | | | |
| Proxel ^{®} | 0.02 | 0.02 | 0.02 | 0.02 | 0.01 | 0.02 |
| Defoamer | 0.03 | 0.03 | 0.03 | 0.03 | 0.02 | 0.03 |

Active ingredient content (wt. %)

| | | | | | | |
|---|---|---|---|---|---|---|
| ACC | 28.45 | 28.45 | 28.51 | 28.51 | 27.83 | 28.51 |
| DFF | 3.39 | 3.39 | 3.40 | 3.40 | 3.32 | 3.40 |
| ACC/DFF ratio | 8.40 | 8.40 | 8.40 | 8.40 | 8.40 | 8.40 |
| MRB | 6.83 | 6.83 | 6.84 | 6.84 | 6.64 | 6.84 |
| Particle size | 6.5 | 4.0 | 5.4 | 4.3 | 7.0 | 6.2 |
| (μm) | | | | | | |

A microcapsule suspension of microcapsules of the present disclosure containing acetochlor and diflufenican in the core were charged in a beaker. The mixture was agitated using a magnetic stirrer. Then, a mill base suspension of mesotrione particles (with a particle size in the range of about 5 μm to 6 μm) obtained by grinding using a wet mill machine was slowly added and continuously mixed for 5 minutes. Copper sulfate pentahydrate was added as solid to effect partial copper chelation of mesotrione. Other inert ingredients such as Kelzan, bactericide and antifoam agent and water were added. The Kelzan was added as a 2% gel solution and mixed for 15 minutes after addition. The resulting suspension was filtered using a No 50 (US mesh standard) screen to remove any big particles formed.

TABLE 1F
3-way premix with Acetochlor, Diflufenican and Mesotrione

| | 5364-8 | 5364-9 | 5364-10 | 6095-1 | 6095-2 |
|---|---|---|---|---|---|
| Constituent | wt % | wt % | wt % | wt % | wt % |
| Acetochlor | 28.49 | 24.27 | 30.91 | 33.66 | 31.68 |
| Diflufenican | 3.38 | 2.89 | 2.45 | 2.00 | 3.80 |
| Mesotrione | 2.69 | 2.44 | 3.09 | 3.32 | 3.30 |
| CuSO₄•5H₂O | 0.72 | 0.65 | 0.83 | 0.89 | 0.88 |
| Aromatic 200 | 14.46 | 19.56 | 10.86 | 6.73 | 6.34 |
| Desmodur | 2.68 | 3.02 | 2.38 | 2.61 | 3.01 |
| 3215 N | | | | | |
| Glycerin | 2.38 | 2.35 | 2.78 | 2.00 | 1.98 |
| REAX 105M | | | | | |
| (40%) | 2.76 | 3.01 | 2.59 | 2.61 | 2.58 |
| Water | 40.97 | 40.08 | 42.64 | 44.55 | 44.60 |
| TETA (50%) | 1.27 | 1.45 | 1.12 | 1.24 | 1.43 |
| Kelzan CC | 0.06 | 0.06 | 0.06 | 0.06 | 0.06 |
| Agnique | 0.04 | 0.04 | 0.04 | 0.03 | 0.04 |
| DFM-111S | | | | | |
| Proxel GXL | 0.06 | 0.06 | 0.06 | 0.06 | 0.06 |
| Invalon DAM | 0.02 | 0.02 | 0.02 | 0.02 | 0.02 |
| (40%) | | | | | |
| NaOH | 0.02 | 0.10 | 0.17 | 0.22 | 0.22 |
| Total | 100.00 | 100.00 | 100.00 | 100.00 | 100.00 |
| pH-value | 3.8 | 3.8 | 3.8 | 3.8 | 3.8 |
| ACC/DFF ratio | 8.40 | 8.40 | 12.61 | 16.83 | 8.34 |

### Example 2. Release Rate Studies

The release rate profile for the purposes of estimating the potential for crop injury caused by the acetamide herbicide (here: acetochlor) of the microcapsules according to the present disclosure was measured in the laboratory using a SOTAX AT-7 (SOTAX Corporation; Horsham, Pa. 19044) agitated dissolution test apparatus. An aqueous slurry containing 1% by weight of the microencapsulated acetochlor herbicide active ingredient was prepared by combining the herbicidal compositions with deionized water and mixing at 150 rounds per minute and 25° C. An aliquot of each solution was sampled at 24 hours. Each aliquot was filtered through a syringe filter (TARGET Cellulose Acetate 0.2 μm, ThermoFisher Scientific) to remove any microcapsules. The resulting solution was then analyzed for actives by HPLC. The results of the release rate tests as presented in Table 2A depict that release rate varies with organic non-polar solvent type (solvent) and microcapsule particle size.

TABLE 2A
Release rate studies

| | Acetochlor content in aqueous media | | | Particle |
|---|---|---|---|---|
| Formulation | outside the microcapsules (ppm) | | | size |
| (solvent) | 0 hour | 4 hours | 24 hours | (μm) |
| 7406-2 (DM 810) | 63.6 | 113.2 | 146.6 | 7.9 |
| 7406-3 (A 200) | 11.5 | 20.0 | 34.0 | 8.5 |
| 7406-4 (A 200) | 10.5 | 20.0 | 38.3 | 8.0 |
| 7406-7 (A 200) | 41.2 | 119.7 | 147.5 | 3.5 |
| 7406-8 (DM 810) | 80.2 | 85.0 | 97.1 | 4.3 |
| 7406-9 (DM 810) | 36.4 | 124.9 | 165.3 | 8.2 |
| 7406-13 (A 200) | 48.3 | 97.6 | 119.3 | 7.5 |
| 7406-14 (DM 810) | 105.2 | 123.7 | 133.8 | 7.8 |
| 7406-16 (DM 810) | 56.9 | 63.2 | 69.7 | 4.2 |
| 7406-18 (DM 810) | 28.0 | 32.7 | 43.0 | 2.1 |

These examples demonstrate, although not only ACC and a higher amount of active ingredients is contained in the same microcapsule, the showed controlled release characteristics of ACC. As in case of microcapsules containing ACC alone, the release rate of ACC for the different microcapsules varied, inter alia depending on ACC loading, capsule size and organic non-polar solvent in the microcapsule core, providing the capability of choosing a suitable formulation for specific applications intended, for example a low release rate for application in soybean and a high release rate for application in corn.

### Example 3: Green House Studies

3A. Evaluation of Pre-Emergent Efficacy for 2-Way (ACC+DFF) and 3-Way (ACC+DFF+MRB) Pre-Mixes (Formulations) According to the Disclosure with Respective Tank-Mixes

Premixes of present disclosure were compared with a tank-mix of ACC (33% a.i., capsule suspension, Warrant®, Bayer) and DFF (500 g/L, suspension concentrate, Brodal®, Bayer) and MRB (75% a.i., granules, TriCor® DF, UPL) as shown in Table 3A below. Eight different pre-mix formulations according to the present disclosure were evaluated for pre-emergent efficacy on difficult to control GR (glyphosate resistant) palmer amaranth (Amaranthus palmeri, AMAPA), waterhemp (Amaranthus tamariscinus, AMATA) and proso millet (Panicum miliaceum, PANMI). PANMI is a grass that is difficult to control, especially with ACC alone, but PANMI has no herbicide resistance. At 21 DAT (days after treatment), fresh weights were recorded for all replications. Percent control was then calculated based on the respective untreated control plants. On GR AMAPA, all pre-mix formulations were equivalent to or greater than the respective tank-mix treatment. On PANMI, all pre-mix formulations provided better control than the tank-mix treatments at both application rates.

TABLE 3A
Pre-emergent efficacy

| | | Formulation & | Rate | % Control | % Control |
|---|---|---|---|---|---|
| Trt # | Product | Loading | (g ai/ha) | AMAPA | PANMI |
| 1 | Warrant ® | ACC 33% a.i. | 630 | 42.3 | 14.7 |
| 1 | Brodal ® | DFF 500 g/L | 75 | | |
| 2 | Warrant ® | ACC 33% a.i. | 1260 | 80.5 | 35.5 |
| 2 | Brodal ® | DFF 500 g/L | 150 | | |
| 3 | Warrant ® | ACC 33% a.i. | 630 | 61.7 | 26.9 |
| 3 | Brodal ® | DFF 500 g/L | 75 | | |
| 3 | TriCor ® DF | MRB 75% a.i. | 140 | | |
| 4 | Warrant ® | ACC 33% a.i. | 1260 | 89.6 | 69.7 |
| 4 | Brodal ® | DFF 500 g/L | 150 | | |
| 4 | TriCor ® DF | MRB 75% a.i. | 280 | | |
| 5 | 7406-36 | 28.5% ACC; | 630 | 92.3 | 95.4 |
| | | 3.4% DFF; | | | |
| | | 6.8% MRB | | | |
| 6 | 7406-36 | 28.5% ACC; | 1260 | 92.8 | 100.0 |
| | | 3.4% DFF; | | | |
| | | 6.8% MRB | | | |
| 7 | 7406-38 | 28.5% ACC; | 630 | 99.1 | 99.5 |
| | | 3.4% DFF; | | | |
| | | 6.8% MRB | | | |
| 8 | 7406-38 | 28.5% ACC; | 1260 | 99.9 | 99.5 |
| | | 3.4% DFF; | | | |
| | | 6.8% MRB | | | |
| 9 | 7406-46 | 28.5% ACC; | 630 | 81.4 | 75.0 |
| | | 3.4% DFF; | | | |
| | | 6.8% MRB | | | |
| 10 | 7406-46 | 28.5% ACC; | 1260 | 96.3 | 91.8 |
| | | 3.4% DFF; | | | |
| | | 6.8% MRB | | | |
| 11 | 7406-47 | 28.5% ACC; | 630 | 91.7 | 85.7 |
| | | 3.4% DFF; | | | |
| | | 6.8% MRB | | | |
| 12 | 7406-47 | 28.5% ACC; | 1260 | 98.2 | 100.0 |
| | | 3.4% DFF; | | | |
| | | 6.8% MRB | | | |
| 13 | 7406-34 | 36.2% ACC; | 630 | 85.4 | 95.1 |
| | | 4.3% DFF | | | |
| 14 | 7406-34 | 36.2% ACC; | 1260 | 100.0 | 99.4 |
| | | 4.3% DFF | | | |
| 15 | 7406-45 | 36.2% ACC; | 630 | 83.8 | 77.2 |
| | | 4.3% DFF | | | |
| 16 | 7406-45 | 36.2% ACC; | 1260 | 98.3 | 87.2 |
| | | 4.3% DFF | | | |
| 17 | 7406-48 | 36.2% ACC; | 630 | 46.6 | 56.2 |
| | | 4.3% DFF | | | |
| 18 | 7406-48 | 36.2% ACC; | 1260 | 74.8 | 93.0 |
| | | 4.3% DFF | | | |
| 19 | 7406-49 | 36.2% ACC; | 630 | 70.9 | 84.1 |
| | | 4.3% DFF | | | |
| 20 | 7406-49 | 36.2% ACC; | 1260 | 92.1 | 100.0 |
| | | 4.3% DFF | | | |
| 21 | Untreated | | 0 | 0.0 | 0.0 |

Volume-15 gal water/acre (140.31 L/ha), nozzle type-XR9501E

3B. Evaluation of Pre-Emergent Efficacy of 2-Way (ACC+DFF) and 3-Way (ACC+DFF+MRB) Formulations According to the Disclosure

ACC, DFF and MRB were used as the commercial products Warrant®, Brodal® and TriCor® DF as described in in Example 3A above. Further, also a DFF+MRB pre-mix (200 g/L DFF+400 g/L MRB, suspension concentrate) was used. For GR (glyphosate resistant) palmer amaranth (AMAPA), at 1× rate, all 2- and 3-way treatments provided >95% control. Except for the DFF+MRB pre-mix, these treatments also provided >95% control of GR AMAPA at ½× rate as well. No single active ingredient provided acceptable control of GR AMAPA in this trial. Formulations 7406-7 (ACC+DFF), 7406-9 (ACC+DFF) and 7406-15 (ACC+DFF+MRB) according to the disclosure provided excellent control of proso millet (PANMI) at both rates tested. Individually, ACC and DFF provided weak control of GR AMAPA and PANMI compared to ACC+DFF pre-mixes according to the disclosure which provided excellent control of both weeds.

TABLE 3B
Pre-emergent efficacy

| | | Loading | Rate (½× | % | % |
|---|---|---|---|---|---|
| | | (a.i. in | and 1×) | Control | Control |
| Trt # | Product | wt. %) | (g ai/ha) | AMAPA | PANMI |
| 1 | Warrant ® | 33 | 630 | 3.3 | 4.2 |
| 2 | Warrant ® | 33 | 1260 | 8.3 | 42.5 |
| 3 | Brodal ® | 42 | 75 | 49.2 | 0.0 |
| 4 | Brodal ® | 42 | 150 | 71.7 | 0.0 |
| 5 | TriCor ® DF | 75 | 140 | 6.7 | 0.0 |
| 6 | TriCor ® DF | 75 | 280 | 49.2 | 18.3 |
| 7 | DFF + MRB | 50.85 | 225 | 62.5 | 0.0 |
| | Pre-Mix | | | | |
| 8 | DFF + MRB | 50.85 | 450 | 94.3 | 15.8 |
| | Pre-Mix | | | | |
| 9 | 7406-7 | 27.7 | 630 | 94.7 | 99.7 |
| 10 | 7406-7 | 27.7 | 1260 | 100.0 | 99.7 |
| 11 | 7406-9 | 31.9 | 630 | 92.7 | 99.7 |
| 12 | 7406-9 | 31.9 | 1260 | 99.7 | 98.3 |
| 13 | 7406-15 | 24.2 | 630 | 100.0 | 99.2 |
| 14 | 7406-15 | 24.2 | 1260 | 100.0 | 99.2 |
| 15 | Untreated | | | 0.0 | 0.0 |
| | Control | | | | |

Volume-15 gal water/acre (140.31 L/ha), nozzle type-XR9501E

3C. Evaluation of Post-Emergent Efficacy of ACC-DFF Pre-Mix 7406-7 According to the Disclosure with ACC, DFF and Tank-Mix of ACC+DFF in Glyphosate Resistant Canola

ACC and DFF were used as the commercial products Warrant® and Brodal® as described in in Example 3A above. The seeds of glyphosate resistant Canola (Roundup Ready® Canola) were planted in 3.5-inches (8.89 cm) square plastic pots filled with a potting media of 75% silt loam and 25% Redi-earth (Sun Gro, Bellevue, Wash.). The temperature conditions were 22° C. day and 17° C. night with 14 hours of supplemental light (approximately 600 microeinsteins). The pots are placed in a controlled-environment greenhouse equipped with sub-irrigation. The treatments applications were applied to the plants with a track sprayer generally using a TTI110015 nozzle spray nozzle. The spray nozzle was 16 inches (40.64 cm) above the top of the plants and a spray volume rate of about 140 L/ha was applied. The plants were sprayed when canola was at the V3-V4 growth stage. Visual ratings (% control) were collected at 14 DAT.

Crop Injury Average from DFF and DFF+ACC tank-mix treatments was approximately the same for the three application rates. ACC and DFF were used as the commercial products Warrant® and Brodal® as described in in Example 3A above. 1× injury was approximately 38%. ACC alone at 1× was about 19%. Injury from the pre-mix formulation was significantly higher than the tank-mix at all treatments—approximately twice as high at each rate, thus providing superior control of canola.

TABLE 3C
Post-emergent efficacy in glyphosate resistant Canola

| | Canola Crop |
|---|---|
| Row Label | Injury Average |
| DFF | 18.3% |
| 150 g ai/ha-1× | 38.1% |
| 75 g ai/ha-½× | 13.8% |
| 38 g ai/ha-¼× | 3.1% |
| ACC | 6.7% |
| 1260 g ai/ha-1× | 19.3% |
| 630 g ai/ha-½× | 2.5% |
| 315 g ai/ha-¼× | 0.0% |
| ACC + DFF (tank mix) | 19.2% |
| 1260 g + 150 g ai/ha-1× | 38.1% |
| 630 g + 75 g ai/ha-½× | 12.5% |
| 315 g + 38 g ai/ha-¼× | 6.9% |
| 7406-7 (pre-mix of the disclosure) | 41.7% |
| 1260 g ai/ha-1× | 80.6% |
| 630 g ai/ha-½× | 27.5% |
| 315 g ai/ha-¼× | 16.9% |

Table 3C shows the results of the comparison of the 2-way premix according to the present disclosure (7406-7) versus single herbicide treatments (ACC alone and DFF alone) as well as the 2-way tank-mix of ACC and DFF. These data show that control by 7406-7 at 1× and 0.5× was statistically significantly greater than that of the 2-way tank-mix of ACC and DFF. When comparing the herbicidal activity of 7406-7 to ACC alone and DFF alone using Colby analysis (S. R. Colby; Weeds 15 (1967), 20-22), the synergistic effect was statistically significant at 1× and 0.5×.

Glyphosate resistant Canola (Roundup Ready® Canola) is a species that is also tolerant to ACC but sensitive to DFF. The date in Table 3C shows that there is very low herbicidal activity by ACC and the activity of DFF alone is about equal to the 2-way tank-mix of ACC and DFF.

3D. Evaluation of Pre-Emergent Efficacy for 2-Way (ACC+DFF) Pre-Mixes (Formulations) According to the Disclosure with Respective Tank-Mixes to Control Multiple Resistant Palmer Amaranth (Amaranthus palmeri) Species

Premixes of present disclosure were compared with ACC and DFF used as the commercial products Warrant® and Brodal® as described in in Example 3A above, as well as a corresponding tank-mix of ACC+DFF. Two different pre-mix formulations according to the present disclosure were evaluated for pre-emergent efficacy on the following difficult to control multiple resistant palmer amaranth (Amaranthus palmeri, AMAPA) species: AMAPA (WR-2015-002), resistant against glyphosate, PPO-, HPPD- and ALS-inhibitor herbicides; and AMAPA (WR-2015-008), resistant against glyphosate and metribuzin (PSII-inhibitor), PPO-, HPPD- and ALS-inhibitor herbicides.

At 21 DAT (days after treatment), visual percent control as well as fresh biomass ratings were recorded for all replications. Fresh biomass percent control was calculated in this trial and showed similar results as the visual percent control ratings. Percent control was then calculated based on the respective untreated control plants. The results as shown in Table 3D below.

Formulations 7406-7 (ACC+DFF) and 7406-9 (ACC+DFF) according to the disclosure provided excellent control of both multiple resistant AMAPA species, all pre-mix formulations were equivalent to or greater than the respective tank-mix treatment.

Both pre-mix formulations 7406-7 (ACC+DFF) and 7406-9 (ACC+DFF) provided more than 98% control of both palmer amaranth lines at both application rates. Overall, both pre-mixes were statistically more efficacious than the ACC+DFF tank-mix at both ½× and 1× application rates.

TABLE 3D
Pre-emergent efficacy on multiple resistant AMAPA

| | Injury Average | |
|---|---|---|
| | AMAPA | AMAPA |
| Row Label | (WR-2015-002) | (WR-2015-008) |
| ACC | | |
| 630 g ai/ha-½× | 61.9% | 60.6% |
| 1260 g ai/ha-1× | 81.6% | 73.8% |
| DFF | | |
| 75 g ai/ha-½× | 51.3% | 65.6% |
| 150 g ai/ha-1× | 70.6% | 75.6% |
| ACC + DFF (tank mix) | | |
| 630 g + 75 g ai/ha-½× | 69.4% | 72.5% |
| 1260 g + 150 g ai/ha-1× | 91.4% | 88.8% |
| 7406-7 (pre-mix of the disclosure) | | |
| 630 g ai/ha-½× | 99.8% | 98.4% |
| 1260 g ai/ha-1× | 100% | 99.8% |
| 7406-9 (pre-mix of the disclosure) | | |
| 630 g ai/ha-½× | 100% | 98.6% |
| 1260 g ai/ha-1× | 100% | 99.8% |
| Untreated Control | 0.0% | 0.0% |

Volume-15 gal water/acre (140.31 L/ha), nozzle type-XR9501E

Premixes of present disclosure were compared with ACC and DFF used as the commercial products Warrant® and Brodal® as described in in Example 3A above, as well as a corresponding tank-mix of ACC+DFF. As shown in Table 3E below, the co-microencapsulated 2-way premix formulations demonstrated better weed control for both application rates of 0.5× and 1×, largely irrespective of the ratio of ACC to DFF. As compared to the Control (ACC and DFF tank-mix), formulations 5875-2, 5875-4 and 5529-100 used only 66.7% of the amount of DFF present in the Control (with same amount of acetochlor), while formulation 5529-75 only used 50% of the DFF amount present in the Control. The results indicate that co-microencapsulated DFF showed improved weed control for glyphosate-resistant AMATA and PANMI.

TABLE 3E
Pre-emergent efficacy with 2-way premixes on AMATA and PANMI

| | | | | | | | | Control |
|---|---|---|---|---|---|---|---|---|
| | | | | | | | | (Warrant ^{®} |
| | | | | | | | | and |
| | | 5875- | 5875- | 5875- | 5529- | 5529- | 7406- | Brodal ^{®} |
| | | 2 | 3 | 4 | 75 | 100 | 45 | tank-mix) |
| Usage rate | ACC | 630 | 630 | 630 | 630 | 630 | 630 | 630 |
| in testing | DFF | 50 | 75 | 50 | 37.5 | 50 | 75 | 75 |
| (0.5X)-g/ha | | | | | | | | |
| Weed | AMATA | 100 | 98.9 | 100.0 | 100.0 | 100.0 | 98.4 | 94.6 |
| control (%, | PANMI | 99.3 | 90.1 | 91.27 | 83.5 | 97.7 | 96.2 | 12.9 |
| Average) | | | | | | | | |
| Usage rate | ACC | 1260.0 | 1260.0 | 1260.0 | 1260.0 | 1260.0 | 1260.0 | 1260.0 |
| in testing | | | | | | | | |
| (1X)-g/ha | DFF | 100.0 | 150.0 | 100.0 | 75.00 | 100.0 | 150.0 | 150.0 |
| Weed | AMATA | 97.3 | 100.0 | 100.0 | 100.00 | 100.0 | 100.00 | 100.0 |
| control (%, | PANMI | 99.84 | 99.62 | 96.28 | 97.09 | 99.8 | 98.5 | 78.7 |
| Average) | | | | | | | | |

Premixes of present disclosure were compared with ACC, DFF and MST used as the commercial products Warrant® and Brodal® and Callisto®. As shown in Table 3F below, the co-microencapsulated 3-way premix formulations of the present disclosure demonstrated very similar or better weed control for glyphosate-resistant AMATA and PANMI at 0.5× and 1× compared to the Control (tank-mix).

TABLE 3F
Pre-emergent efficacy with 3-way
premixes on AMATA and PANMI

| | | | | Control (Warrant ®, |
|---|---|---|---|---|
| | | | | Brodal ® and |
| | | 5364-9 | 5364-10 | Callisto ® tank-mix) |
| Usage rate | ACC | 630 | 630 | 630 |
| in testing | DFF | 75 | 50 | 75 |
| (0.5×)-g/ha | MST | 63 | 63 | 63 |
| Weed control | AMATA | 100 | 100 | 100 |
| (%, Average) | PANMI | 97.66 | 75.42 | 73.37 |
| Usage rate | ACC | 1260 | 1260 | 1260 |
| in testing | DFF | 150 | 100 | 150 |
| (1×)-g/ha | MST | 126 | 126 | 126 |
| Weed control | AMATA | 100 | 100 | 100 |
| (%, Average) | PANMI | 99.11 | 99.13 | 99.80 |

### Example 4

4. Evaluation of the Solubility of DFF (and MRB) in ACC and Different Organic Non-Polar Solvents and their Usefulness for the Production of Microcapsules

Different organic non-polar solvents were tested and assessed for their suitability to allow the incorporation of DFF together with ACC into the core of microcapsules according to the present disclosure. It was found that certain organic non-polar solvents like aromatic hydrocarbons and fatty acid dimethylamides were more suitable than other organic non-polar solvents like paraffinic solvents (Isopar M, Norpar 15 or Conosol C-170).

Co-Microencapsulation of ACC and DFF without Organic Solvents

A mixture of 50 g Acetochlor (96%)+6.1 g DFF (94.3%) formed a liquid at high temperature of about 80° C., but crystals formed once cooled down to room temperature (about 25° C.). Severe crystallization was observed for this mixture. The microcapsules obtained using this mixture showed deformed shape.

Co-Microencapsulation of ACC and DFF with Different Organic Non-Polar Solvents

It was found that DFF could be dissolved in the mixture containing ACC and the respective organic non-polar solvent at high temperature. Depending on the type of the organic non-polar solvent severe crystallization and/or phase separation happened quickly once the mixtures were cooled down to room temperatures making such (types of) organic non-polar solvents less suitable for producing microcapsules according to the present disclosure.

In these tests, all mixtures had the following composition: 100 g Acetochlor (96%)+12.12 g DFF (94.3%)+40 g of the respective solvent (“Solvent” in Table 4A). Each mixture was heated to about 75° C. for complete dissolution of the added solid DFF and subsequently cooled down to room temperature (about 25° C.) followed by visual assessment (“Assessment” in Table 4A) of the respective mixture.

TABLE 4A
Tests and Assessment of Co-microencapsulation of ACC and DFF

| Sample # | Solvent | Assessment |
|---|---|---|
| 1 | Isopar M | Severe crystallization |
| 2 | Norpar 15 | Severe crystallization and |
| | | severe phase separation |
| 3 | Conosol C-170 | Severe crystallization |
| 4 | Aromatic 200 | Clear liquid, no crystallization |
| 5 | Armid DM810 | Clear liquid, no crystallization |

Co-Microencapsulation of ACC, DFF and MRB with Different Organic Non-Polar Solvents

It was found that DFF and MRB could be dissolved in the mixture containing ACC and the respective organic non-polar solvent at high temperature. Depending on the type of the organic non-polar solvent severe crystallization and/or phase separation happened quickly once the mixtures were cooled down to room temperatures making such (types of) organic non-polar solvents less suitable for producing microcapsules according to the present disclosure.

In these tests, all mixtures had the following composition: 100 g Acetochlor (96%)+12.12 g DFF (94.3%)+23.45 g MRB (97%)+40 g of the respective solvent (“Solvent” in Table 4B). Each mixture was heated to about 75° C. for complete dissolution of the added solid DFF and MRB, and subsequently cooled down to room temperature (about 25° C.) followed by visual assessment (“Assessment” in Table 4B) of the respective mixture.

TABLE 4B
Tests and Assessment of Co-microencapsulation
of ACC, DFF and MRB

| Sample # | Solvent | Assessment |
|---|---|---|
| 6 | Isopar M | Severe crystallization and phase |
| | | separation |
| 7 | Norpar 15 | Severe crystallization and severe |
| | | phase separation |
| 8 | Conosol C-170 | Severe crystallization |
| 9 | Aromatic 200 | Clear liquid and slight crystallization |
| 10 | Armid DM810 | Clear liquid, no crystallization |

The results above show that certain types of organic non-polar solvents, in particular linear, branched or cyclic paraffinic hydrocarbons, are less suitable as (part of) constituent (iii) of the microcapsules of the present disclosure than other organic non-polar solvents like aromatic solvents or fatty acid N,N-dimethylamides based solvents. These more suitable organic non-polar solvents as (part of) constituent (iii) of the core of the microcapsules of the present disclosure allow avoidance of problems in the manufacturing process of the microcapsules according to the present disclosure, yield a more uniform population of microcapsules with an essentially homogeneous core of the microcapsules (e.g. essentially free of crystals of DFF, and if applicable, MRB), overall achieving more uniform and reliable release properties of the active ingredients ACC and DFF, and if applicable, MRB, from the microcapsules. Warrant®, Brodal®.

### Example 5: Field Studies

Evaluation of Pre-Emergent Efficacy for 2-Way (ACC+DFF) Pre-Mixes (Formulations) According to the Disclosure with Respective Tank-Mixes

As shown in Table 5A below, the 2-way ACC+DFF premixes were tested for weed efficacy at 21 DAT and 42 DAT. The results indicate better or equivalent control for glyphosate-resistant AMAPA and AMATA when compared to the corresponding tank-mixes (ACC+DFF).

TABLE 5A
Pre-emergent weed efficacy

| | | | |
|---|---|---|---|
| | Active usage | % Control | % Control |
| Product | rate (g/ha) | AMAPA | AMATA |

21 DAT

| | | | |
|---|---|---|---|
| 7406-34 | 1260 ACC + | 99 | 100 |
| 7406-45 | 150 DFF (1X) | 100 | 100 |
| Warrant ^{®} + Brodal ^{®} | | 97 | 99 |
| (tank-mix) | | | |

42 DAT

| | | | |
|---|---|---|---|
| 7406-34 | 1260 ACC + | 95 | 89 |
| 7406-45 | 150 DFF (1X) | 95 | 88 |
| Warrant ^{®} + Brodal ^{®} | | 90 | 87 |
| (tank-mix) | | | |

As shown in Table 5B below, the 2-way ACC+DFF premixes were also tested for crop response (damage, injury) on soybean when applied as a pre-emergent herbicide. The results indicate lower or equivalent crop response when compared to the corresponding tank-mix (ACC+DFF) at 1× and 2× rates, in particular 7 or 15 DAT.

TABLE 5B
Pre-emergent crop response on soybean

| | Active usage | 7 | 15 | 30 |
|---|---|---|---|---|
| | rate (g/ha) | DAT | DAT | DAT |
| 7406-34 | 1260 ACC + | 4 | 2 | 1 |
| 7406-45 | 150 DFF (1X) | 2 | 2 | 0 |
| Wanant ^{®} + Brodal ^{®} | | 5 | 3 | 1 |
| (tank-mix) | | | | |
| 7406-34 | 2520 ACC + | 11 | 6 | 2 |
| 7406-45 | 300 DFF (2X) | 8 | 6 | 2 |
| Warrant ^{®} + | | 14 | 8 | 1 |
| Brodal ^{®} (tank-mix) | | | | |

5C. Evaluation of Pre-Emergent Efficacy for 3-Way (ACC+DFF+MRB) Pre-Mixes (Formulations) According to the Disclosure with Respective Tank-Mixes

As shown in Table 5C below, the 3-way ACC+DFF+MRB premixes were tested for weed efficacy at 21 DAT and 42 DAT. The results indicate better or similar control for glyphosate-resistant AMAPA and AMATA when compared to the corresponding tank-mix (ACC+DFF+MRB).

TABLE 5C
Pre-emergent weed efficacy

| | | | |
|---|---|---|---|
| | Active usage | % Control | % Control |
| Product | rate (g/ha) | AMAPA | AMATA |

21 DAT

| | | | |
|---|---|---|---|
| 7406-36 | 1260 ACC + | 98 | 99 |
| 7406-38 | 150 DFF + 300 | 100 | 100 |
| 7406-46 | MRB | 99 | 100 |
| 7406-47 | | 100 | 100 |
| Wanant ^{®} + Brodal ^{®} | | 100 | 100 |
| (tank-mix) | | | |

42 DAT

| | | | |
|---|---|---|---|
| 7406-36 | 1260 ACC + | 97 | 92 |
| 7406-38 | 150 DFF + 300 | 97 | 97 |
| 7406-46 | MRB | 97 | 89 |
| 7406-47 | | 98 | 93 |
| Wanant ^{®} + Brodal ^{®} | | 100 | 85 |
| (tank-mix) | | | |

As shown in Table 5D below, the 3-way ACC+DFF+MRB premixes were also tested for crop response (damage, injury) on soybean when applied as a pre-emergent herbicide. The results indicate lower or similar crop response when compared to the corresponding tank-mix (ACC+DFF+MRB) at 1× and 2× rates.

TABLE 5D
Pre-emergent crop response in soybean

| | Active usage | 7 | 15 | 30 |
|---|---|---|---|---|
| | rate (g/ha) | DAT | DAT | DAT |
| 7406-36 | 1260 ACC + | 3 | 3 | 1 |
| 7406-38 | 150 DFF + 300 | 6 | 5 | 1 |
| 7406-46 | MRB | 2 | 3 | 1 |
| 7406-47 | (1X) | 2 | 3 | 1 |
| Wanant ^{®} + Brodal ^{®} + | | 6 | 5 | 1 |
| TriCor ^{®} DF (tank-mix) | | | | |
| 7406-36 | 2520 ACC + | 12 | 8 | 2 |
| 7406-38 | 300 DFF + 600 | 16 | 10 | 2 |
| 7406-46 | MRB (2X) | 8 | 6 | 2 |
| 7406-47 | | 12 | 9 | 2 |
| Wanant ^{®} + Brodal ^{®} + | | 15 | 11 | 2 |
| TriCor ^{®} DF (tank-mix) | | | | |

### Embodiments

For further illustration, embodiments of the present disclosure are set forth below.

Embodiment 1 is a microcapsule comprising: a polymeric shell wall; and a water-immiscible core material comprising (i) an acetamide herbicide, (ii) diflufenican and (iii) one or more organic non-polar solvent; wherein the total weight of the (i) acetamide herbicide and (ii) diflufenican comprises at least about 5 wt. % of the microcapsule.

Embodiment 2 is the microcapsule of Embodiment 1, wherein the total weight of (i) acetamide herbicide and (i) diflufenican is at least about 10 wt. %, preferably at least about 15 wt. %, more preferably at least about 20 wt. %, even more preferably at least about 25 wt. %, and particularly preferably at least about 30 wt. %, in each case based on the total weight of the microcapsule; and/or the ratio by weight of the total amount of (i) acetamide herbicide to the total amount of (ii) diflufenican is in the range of from about 3:1 to about 15:1, preferably of from about 4:1 to about 12:1, more preferably in the range of from about 6:1 to about 10:1, even more preferably in the range of from about 7:1 to about 9:1.

Embodiment 2a is the microcapsule of Embodiment 1, wherein the total weight of (i) acetamide herbicide and (i) diflufenican is at least about 10 wt. %, preferably at least about 15 wt. %, more preferably at least about 20 wt. %, even more preferably at least about 25 wt. %, and particularly preferably at least about 30 wt. %, in each case based on the total weight of the microcapsule; and/or wherein the ratio by weight of the total amount of (i) acetamide herbicide to the total amount of (ii) diflufenican is in the range of from about 3:1 to about 20:1, preferably of from about 4:1 to about 18:1, more preferably in the range of from about 6:1 to about 18:1, even more preferably in the range of from about 7:1 to about 17:1.

Embodiment 3 is the microcapsule of Embodiment 1 or 2 or 2a, wherein the (i) acetamide herbicide comprises at least one herbicide selected from the group consisting of acetochlor, alachlor, butachlor, butenachlor, delachlor, diethatyl and agriculturally acceptable esters thereof, dimethachlor, dimethenamid, dimethenamid-P, mefenacet, metazachlor, metolachlor, S-metolachlor, napropamide, pretilachlor, pronamide, propachlor, propisochlor, prynachlor, terbuchlor, thenylchlor and xylachlor, or agriculturally acceptable esters thereof, and combinations thereof.

Embodiment 4 is the microcapsule of any one of Embodiments 1 to 3, wherein the (i) acetamide herbicide comprises or consists of acetochlor.

Embodiment 5 is the microcapsule of any one of Embodiments 1 to 4, wherein the microcapsules are characterized as having a mean particle size range of from about 2 μm to about 15 μm, from about 2 μm to about 12 μm, from about 2 μm to about 10 μm, from about 2 μm to about 8 μm, from about 3 μm to about 15 μm, from about 3 μm to about 10 μm, from about 3 μm to about 8 μm, from about 4 μm to about 15 μm, from about 4 μm to about 12 μm, from about 4 μm to about 10 μm, from about 4 μm to about 8 μm, or from about 4 μm to about 7 μm.

Embodiment 6 is the microcapsule of any one of Embodiments 1 to 4, wherein the microcapsules are characterized as having a mean particle size range of from about 3 μm to about 9 μm,

Embodiment 7 is the microcapsule of any one of Embodiments 1 to 6, wherein the total weight of the (i) acetamide herbicide is from about 10 wt. % to about 15 wt. %, from about 15 wt. % to about 20 wt. %, from about 20 wt. % to about 25 wt. %, from about 25 wt. % to about 30 wt. %, from about 30 wt. % to about 35 wt. %, from about 35 wt. % to about 40 wt. %, or from about 40 wt. % to about 45 wt. % of the microcapsule.

Embodiment 8 is the microcapsule of any one of Embodiments 1 to 6, wherein the total weight of the (i) acetamide herbicide, preferably of acetochlor, is in the range of from about 10 wt. % to about 50 wt. %, from about 10 wt. % to about 45 wt. %, from about 15 wt. % to about 45 wt. %, from about 15 wt. % to about 40 wt. %, from about 20 wt. % to about 40 wt. %, from about 25 wt. % to about 40 wt. %, or from about 30 wt. % to about 40 wt. % of the microcapsule.

Embodiment 9 is the microcapsule of any one of Embodiments 1 to 8, wherein the total weight of the (i) acetamide herbicide is at least about 20 wt. %, at least about 25 wt. %, or at least about 30 wt. % of the microcapsule.

Embodiment 10 is the microcapsule of any one of Embodiments 1 to 9, wherein the total weight of (ii) diflufenican is from about 2.0 wt. % to about 2.5 wt. %, from about 2.5 wt. % to about 3.0 wt. %, from about 3.0 wt. % to about 3.5 wt. %, from about 3.5 wt. % to about 4.0 wt. %, from about 4.0 wt. % to about 4.5 wt. %, or from about 4.5 wt. % to about 5.0 wt. % of the microcapsule.

Embodiment 11 is the microcapsule of any one of Embodiments 1 to 9, wherein the total weight of (ii) diflufenican is in the range of from about 2.0 wt. % to about 6.0 wt. %, from about 2.5 wt. % to about 5.5 wt. %, from about 2.5 wt. % to about 5.0 wt. %, from about 2.5 wt. % to about 4.5 wt. %, from about 3.0 wt. % to about 4.5 wt. % of the microcapsule.

Embodiment 11a is the microcapsule of any one of Embodiments 1 to 9, wherein the total weight of (ii) diflufenican is in the range of from about 1.0 wt. % to about 6.0 wt. %, from about 1.25 wt. % to about 5.0 wt. %, from about 1.25 wt. % to about 4.5 wt. %, from about 1.5 wt. % to about 4.0 wt. %, from about 1.5 wt. % to about 3.0 wt. % of the microcapsule.

Embodiment 12 is the microcapsule of any one of Embodiments 1 to 9, wherein, wherein the total weight of (ii) diflufenican is at least about 2.0 wt. %, or at least about 3.0 wt. % of the microcapsule.

Embodiment 12a is the microcapsule of any one of Embodiments 1 to 9, wherein, wherein the total weight of (ii) diflufenican is at least about 1.0 wt. %, or at least about 1.5 wt. % of the microcapsule.

Embodiment 13 is the microcapsule of any one of Embodiments 1 to 12a, wherein the water-immiscible core material comprises one or more further herbicides (i.e. different from the (i) acetamide herbicides and (ii) diflufenican)), preferably a Photosystem II inhibitor herbicide which is preferably selected from the group consisting of ametryn, amicarbazone, atrazine, bentazon, bromacil, bromoxynil, chlorotoluron, cyanazine, desmedipham, desmetryn, dimefuron, diuron, fluometuron, hexazinone, ioxynil, isoproturon, linuron, metamitron, methibenzuron, metoxuron, metribuzin, monolinuron, phenmedipham, prometon, prometryn, propanil, pyrazon, pyridate, siduron, simazine, simetryn, tebuthiuron, terbacil, terbumeton, terbuthylazine and trietazine, and combinations thereof, more preferably the Photosystem II inhibitor is metribuzin.

Embodiment 14 is the microcapsule of Embodiment 13, wherein, wherein the total weight of the Photosystem II inhibitors, preferably of metribuzin, is at least about 4.5 wt. %, at least about 5.0 wt. %, or at least about 5.5 wt. % of the microcapsule.

Embodiment 15 is the microcapsule of Embodiments 13 or 14, wherein wherein the total weight of the Photosystem II inhibitors, preferably of metribuzin, is from about 4.5 wt. % to about 5.0 wt. %, from about 5.0 wt. % to about 5.5 wt. %, from about 5.5 wt. % to about 6.0 wt. %, from about 6.0 wt. % to about 6.5 wt. %, from about 6.5 wt. % to about 7.0 wt. %, or from about 7.0 wt. % to about 7.5 wt. % of the microcapsule.

Embodiment 16 is the microcapsule of any one of Embodiments 13 to 15, wherein the total weight of metribuzin is in the range of from about 4.0 wt. % to about 8.0 wt. %, from about 4.5 wt. % to about 7.5 wt. %, from about 5.0 wt. % to about 7.5 wt. %, from about 5.5 wt. % to about 7.5 wt. % of the microcapsule.

Embodiment 17 is the microcapsule of any one of Embodiments 1 to 16, wherein the total weight of the microencapsulated herbicides is from about 15 wt. % to about 20 wt. %, from about 20 wt. % to about 25 wt. %, from about 25 wt. % to about 30 wt. %, from about 30 wt. % to about 35 wt. %, from about 35 wt. % to about 40 wt. %, from about 40 wt. % to about 45 wt. %, from about 45 wt. % to about 50 wt. %, or from about 50 wt. % to 55 wt. % of the microcapsule.

Embodiment 18 is the microcapsule of any one of Embodiments 1 to 17, wherein the total weight of the microencapsulated herbicides is in the range of from about 15 wt. % to about 60 wt. % of the microcapsule, preferably from about 20 wt. % to about 60 wt. %, from about 25 wt. % to about 55 wt. %, from about 30 wt. % to about 55 wt. %., from about 35 wt. % to about 55 wt. %.

Embodiment 19 is the microcapsule of any one of Embodiments 1 to 18, wherein the ratio by weight of the total weight of the (i) acetamide herbicide to the total weight of the (iii) organic non-polar solvents in said microcapsule is in the range of from in the range of from 3:2 to 20:1, preferably 3:2 to 15:1, more preferably in the range of from 5:3 to 12:1, even more preferably in the range of from 2:1 to 10:1.

Embodiment 20 is the microcapsule of any one of Embodiments 1 to 19, wherein the total weight of the (i) acetamide herbicide and the (iii) organic non-polar solvents is at least about 25 wt. % of the microcapsule, preferably at least about 30 wt. %, more preferably at least about 35 wt. %, more preferably at least about 40 wt. %.

Embodiment 21 is the microcapsule of any one of Embodiments 1 to 20, wherein the water-immiscible core material further comprises a herbicide safener, preferably selected from the group consisting of benoxacor, cloquintocet-methyl, cloquintocet-mexyl, cyprosulfamide, fenchlorazole-ethyl, furilazole, isoxadifen-ethyl and mefenpyr-diethyl.

Embodiment 22 is the microcapsule of any one of Embodiments 1 to 21, wherein the (iii) organic non-polar solvent comprises or consists of aromatic hydrocarbons, fatty acid dimethylamides, fatty acid esters, and mixtures thereof.

Embodiment 23 is the microcapsule of any one of Embodiments 1 to 22, wherein the (iii) organic non-polar solvent comprises or consist of one or more aromatic hydrocarbons, preferably one or more aromatic hydrocarbons C10-C16; or one or more C6-C18 fatty acid N,N-dimethylamides, preferably one or more C8-C12 fatty acid N,N-dimethylamides; and/or mixtures thereof.

Embodiment 24 is the microcapsule of any one of Embodiments 1 to 23, wherein the (iii) organic non-polar solvent comprises or consists of N,N-dimethyloctanamide, N,N-dimethyldecanamide and mixtures thereof.

Embodiment 25 is the microcapsule of any one of Embodiments 1 to 24, wherein the total weight of the (iii) organic non-polar solvent is at least about 5 wt. %, at least about 6 wt. %, at least about 7 wt. %, at least about 8 wt. %, at least about 9 wt. %, or at least about 10 wt. % of the microcapsule.

Embodiment 26 is the microcapsule of any one of Embodiments 1 to 25, wherein the total weight of the (iii) organic non-polar solvent is from about 5 wt. % to about 8 wt. %, from about 8 wt. % to about 11 wt. %, from about 11 wt. % to about 14 wt. %, from about 14 wt. % to about 17 wt. %, or from about 17 wt. % to about 20 wt. % of the microcapsule.

Embodiment 27 is the microcapsule of any one of Embodiments 1 to 25, wherein the total weight of the (iii) organic non-polar solvent is in the range of from about 5 wt. % to about 25 wt. %, from about 5 wt. % to about 20 wt. %, from about 8 wt. % to about 20 wt. %, from about 11 wt. % to about 17 wt. % of the microcapsule.

Embodiment 28 is the microcapsule of any one of Embodiments 1 to 27, wherein the polymeric shell wall comprises or consists of organic polymers, preferably selected from the group consisting of polyurea, polyurethane, polycarbonate, polyamide, polyester and polysulfonamide, and mixtures thereof.

Embodiment 29 is the microcapsule of any one of Embodiments 1 to 28, wherein the polymeric shell wall is a polyurea shell wall formed in a polymerization medium by a polymerization reaction between a polyisocyanate component comprising a polyisocyanate or mixture of polyisocyanates and a polyamine component comprising a polyamine or mixture of polyamines to form the polyurea.

Embodiment 30 is the microcapsule of Embodiment 29, wherein the polyisocyanate component comprises an aliphatic polyisocyanate.

Embodiment 31 is the microcapsule of Embodiment 29 or 30, wherein the polyamine component comprises a polyamine of the structure NH₂(CH₂CH₂NH)ₘCH₂CH₂NH₂ where m is from 1 to 5, 1 to 3, or 2.

Embodiment 32 is the microcapsule of Embodiments 30 or 31, wherein the polyamine component is selected from the group consisting of substituted or unsubstituted polyethyleneamine, polypropyleneamine, diethylene triamine, triethylenetetramine (TETA), and combinations thereof, preferably the polyamine component is triethylenetetramine (TETA).

Embodiment 33 is the microcapsule of any one of Embodiments 29 to 32, wherein the ratio of amine molar equivalents contained in the polyamine component to isocyanate molar equivalents contained in the polyisocyanate component is at least about 0.9:1, at least about 0.95:1, at least about 1:1, at least about 1.01:1, at least about 1.05:1, or at least about 1.1:1.

Embodiment 34 is the microcapsule of any one of Embodiments 29 to 34, wherein the polyurea shell wall is formed in a polymerization medium by a polymerization reaction between a polyisocyanate component comprising a polyisocyanate or mixture of polyisocyanates and a polyamine component comprising a polyamine or mixture of polyamines to form the polyurea and the ratio of amine molar equivalents contained in the polyamine component to isocyanate molar equivalents contained in the polyisocyanate component is from about from 1.01:1 to about 1.3:1, preferably from 1.01:1 to about 1.25:1, from 1.01:1 to about 1.2:1, from about 1.05:1 to about 1.3:1, from about 1.05:1 to about 1.25:1, from about 1.05:1 to about 1.2:1, from about 1.1:1 to about 1.3:1, from about 1.1:1 to about 1.25:1, and from about 1.1:1 to about 1.2:1.

Embodiment 35 is a method of making a microcapsule of any one of Embodiments 1 to 34, wherein the microcapsule is a polyurea core-shell microcapsule, comprising the steps of: (a) Preparing a liquid mixture by dissolving diflufenican, and optionally a further herbicide, preferably a Photosystem II inhibitor, in a mixture comprising or consisting of acetamide herbicide (preferably acetochlor) and an organic non-polar solvent (or mixture of organic non-polar solvents) at a temperature in the range of from about 50 to 75° C., preferably at about 65° C.; (b) Adding a polyisocyanate component, preferably comprising or consisting of one or more aliphatic polyisocyanate components, into the liquid mixture of step (a); (c) Preparing an emulsifier-containing aqueous solution, wherein the total amount of emulsifiers is in the range of from about 0.5 to about 5% by weight; (d) Heating the emulsifier-containing aqueous solution of step (c) to a temperature in the range of from about 50 to 75° C., preferably to a temperature of about 65° C.; (e) Adding the liquid mixture resulting from step (b) into the heated emulsifier-containing aqueous solution of step (d), under (vigorous) mixing; (f) Adding a polyamine component, preferably comprising or consisting of one or more polyamine components selected from the group consisting of substituted or unsubstituted polyethyleneamine, polypropyleneamine, diethylene triamine, triethylenetetramine (TETA), and combinations thereof, (slowly) into the emulsion resulting from step (e) under (mild) agitation (mixing) and keeping the emulsion at a temperature in the range of from about 50 to 75° C., preferably at about 65° C., for about 30 minutes to about 120 minutes, preferably for about 60 minutes; (g) Cooling the mixture resulting from step (f), preferably to a temperature in the range of 10 to 35° C., typically to room temperature (about 25° C.).

Embodiment 36 is a method of making a microcapsule of any one of Embodiments 1 to 34, wherein the microcapsule is a polyurea core-shell microcapsule, comprising the steps of: (a) Preparing a liquid mixture by dissolving diflufenican, and optionally metribuzin, in a mixture comprising or consisting of acetochlor and an organic non-polar solvent or mixture of organic non-polar solvents at a temperature in the range of from about 50 to 75° C., preferably at about 65° C.; (b) Adding a polyisocyanate component comprising or consisting of one or more aliphatic polyisocyanate components into the liquid mixture of step (a); (c) Preparing an emulsifier-containing aqueous solution, wherein the total amount of emulsifiers is in the range of from about 0.5 to about 5% by weight, and wherein said emulsifiers preferably comprise or consist of lignin sulfonates or maleic acid-olefin copolymers; (d) Heating the emulsifier-containing aqueous solution of step (c) to a temperature in the range of from about 50 to 75° C., preferably to a temperature of about 65° C.; (e) Adding the liquid mixture resulting from step (b) into the heated emulsifier-containing aqueous solution of step (d), under (vigorous) mixing; (f) Adding a polyamine component comprising or consisting of triethylenetetramine (TETA) (slowly) into the emulsion resulting from step (e) under (mild) agitation (mixing) and keeping the emulsion at a temperature at about 65° C., for about 30 minutes to about 120 minutes, preferably for about 60 minutes; (g) Cooling the mixture resulting from step (f), preferably to a temperature in the range of 10 to 35° C., typically to room temperature (about 25° C.).

Embodiment 37 is the method of making a microcapsule according to Embodiment 35 or 36, wherein the ratio of amine molar equivalents contained in the polyamine component to isocyanate molar equivalents contained in the polyisocyanate component is from about 1:01 to about 1.2:1.

Embodiment 38 is a herbicidal composition comprising the microcapsule of any one of Embodiments 1 to 34.

Embodiment 39 is the herbicidal composition of Embodiment 38, wherein the composition is in the form of a concentrate.

Embodiment 40 is the herbicidal composition of Embodiment 38, wherein the composition is in the form of a diluted spray application mixture.

Embodiment 41 is the herbicidal composition of any one of Embodiment 38 to 40, wherein the composition comprises an aqueous phase, preferably an aqueous continuous phase.

Embodiment 42 is the herbicidal composition of any one of Embodiment 38 to 41, wherein the microcapsules of any one of Embodiments 1 to 30 are dispersed therein, preferably dispersed in the aqueous phase.

Embodiment 43 is the herbicidal composition of any one of Embodiment 38 to 43, wherein the composition comprises one or more further adjuvants, formulation auxiliaries or additives customary in crop protection.

Embodiment 44 is the herbicidal composition of any one of Embodiment 38 to 43, wherein the composition comprises one or more further pesticides, preferably one or more further herbicides and/or one or more safeners.

Embodiment 44a is the herbicidal composition of Embodiment 44, wherein the herbicidal composition additionally comprises mesotrione.

Embodiment 44b is the herbicidal composition of Embodiment 44a, wherein the total weight of mesotrione on an acid equivalent (ae) basis is from about 1.0 wt. % to about 5.0 wt. %, preferably from about 1.5 wt. % to about 4.5 wt. %, more preferably from about 1.75 wt. % to about 4.0 wt. %, even more preferably from about 2.0 wt. % to about 3.5 wt. %, in each case based on the total weight of the herbicidal composition.

Embodiment 45 is the herbicidal composition of any one of Embodiment 38 to 44, wherein the composition, preferably the aqueous phase of the composition, more preferably the aqueous continuous phase of the composition, further comprises one or more emulsifiers.

Embodiment 46 is the herbicidal composition of any one of Embodiment 38 to 45, wherein the composition, preferably the aqueous phase of the composition, more preferably the aqueous continuous phase of the composition, further comprises one or more formulation adjuvants, preferably selected from anti-freezing agents (such as urea, glycol and glycerin), substances for controlling microorganism growth (such as bactericides), and stabilizers to help physically stabilize the formulation and/or for controlling the formulation viscosity (such as natural or synthetic polymers such as Xanthan gum, guar gum, agar, carboxymethyl cellulose).

Embodiment 47 is a method of making the herbicidal composition in the form of a diluted spray application mixture of any one of Embodiments 40 to 46, wherein the concentrate of Embodiment 39 is poured (slowly) into a water contained vessel under (mild) agitation.

Embodiment 48 is the method according to Embodiment 47, wherein the amount of water used is such that the concentration of acetochlor in the resulting diluted spray application mixture is in the range of from about 0.7% to about 1.5% by weight, preferably in the range of from about 0.9% to about 1.3% by weight.

Embodiment 49 is the method according to Embodiment 47, wherein the ratio by weight of water to concentrate is in the range of from about 1:50 to about 1:10, preferably in the range of from about 1:40 to about 1:15, more preferably in the range of from about 1:30 to about 1:20.

Embodiment 50 is a method for controlling undesired vegetation, preferably in a field of a crop plant, the method comprising applying to the field a herbicidal composition of any one of Embodiments 38 to 46 or a dilution thereof.

Embodiment 51 is the method of Embodiment 50, wherein the crop plant is selected from the group consisting of soybean, corn, canola, cotton, peanuts, potatoes, sugarbeets and/or wheat.

Embodiment 52 is the method of Embodiment 51, wherein the crop plant is soybean.

Embodiment 53 is the method of Embodiment 51, wherein the crop plant is corn.

Embodiment 54 is the method of any one of Embodiments 50 to 53, wherein the application mixture is applied to the field (i) prior to planting the crop plant or (ii) pre-emergence to the crop plant.

Embodiment 55 is the method of any one of Embodiments 50 to 53, wherein the application mixture is applied to the field post-emergence to the crop plant.

Embodiment 56 is the method of any one of Embodiments 50 to 55, wherein the crop plants have one or more herbicide tolerant traits.

Embodiment 57 is the method of any one of Embodiments 50 to 56, wherein the method is carried out for controlling difficult to control weeds or plants.

Embodiment 58 is the method of any one of Embodiments 50 to 57, wherein the method is carried out for controlling weeds or plants having a resistance to herbicides of one, two, three, four, five or more different Modes of Action, wherein resistances preferably are selected from the group consisting of auxin resistance, glyphosate resistance, acetolactate synthase (ALS) inhibitor resistance, 4-hydroxyphenylpyruvate dioxygenase (HPPD) inhibitor resistance, CoA carboxylase (ACCase) inhibitor resistance, photosystem I (PS I) inhibitor resistance, photosystem II (PS II) inhibitor resistance, protoporphyrinogen oxidase (PPO) inhibitor resistance, phytoene desaturase (PDS) inhibitor resistance and synthesis of very long-chain fatty acid (VLCFA) inhibitor resistance.

Embodiment 59 is the method of any one of Embodiments 50 to 58, wherein the method is carried out for controlling weeds or plants having a resistance to glyphosate.

Embodiment 60 is the method of any one of Embodiments 50 to 59, wherein the method is carried out for controlling weeds or plants having a resistance to glyphosate and one, two, three, four or more further resistances, preferably selected from the group consisting of acetolactate synthase (ALS) inhibitor resistance, photosystem II (PS II) inhibitor resistance, 4-hydroxyphenylpyruvate dioxygenase (HPPD) inhibitor resistance, phytoene desaturase (PDS) inhibitor resistance and protoporphyrinogen oxidase (PPO) inhibitor resistance.

Embodiment 61 is a composition suitable to be used as water-immiscible core material for producing a microcapsule according to any one Embodiments 1 to 34, wherein the composition comprises or consists of: (i) an acetamide herbicide, preferably an acetamide herbicide of Embodiment 3 or 4; (ii) diflufenican; and (iii) an organic non-polar solvent, preferably an organic non-polar solvent of Embodiments 22 to 24; and optionally (iv) metribuzin.

Examples and embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more exemplary embodiments disclosed herein may provide all or none of the above mentioned advantages and improvements and still fall within the scope of the present disclosure.

Specific values disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may also be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Having described the disclosure in detail, it will be apparent that modifications and variations are possible without departing from the scope of the disclosure defined in the appended claims. In view of the above, it will also be seen that the several objects of the disclosure are achieved and other advantageous results attained. As various changes could be made in the above compositions and methods without departing from the scope of the disclosure, it is intended that all matter contained in the above description shall be interpreted as illustrative and not in a limiting sense.

What is claimed is:

1. A microcapsule comprising:
a polymeric shell wall and
a water-immiscible core material comprising (i) an acetamide herbicide, (ii) diflufenican and (iii) one or more organic non-polar solvent
wherein a total weight of the (i) acetamide herbicide and (ii) diflufenican comprises at least about 5 wt. % of the microcapsule.

2. The microcapsule of claim 1, wherein the total weight of (i) acetamide herbicide and (i) diflufenican is at least about 10 wt. %; and/or
wherein a ratio by weight of a total amount of (i) acetamide herbicide to a total amount of (ii) diflufenican is in the range of from about 3:1 to about 20:1.

3. The microcapsule of claim 1, wherein the (i) acetamide herbicide comprises at least one herbicide selected from the group consisting of acetochlor, alachlor, butachlor, butenachlor, delachlor, diethatyl and agriculturally acceptable esters thereof, dimethachlor, dimethenamid, dimethenamid-P, mefenacet, metazachlor, metolachlor, S-metolachlor, napropamide, pretilachlor, pronamide, propachlor, propisochlor, prynachlor, terbuchlor, thenylchlor and xylachlor, or agriculturally acceptable esters thereof, and combinations thereof.

4. (canceled)

5. The microcapsule of claim 1, wherein the microcapsules are characterized as having a mean particle size range of from about 2 μm to about 15 μm.

6.-7. (canceled)

8. The microcapsule of claim 1, wherein a total weight of the (i) acetamide herbicide is at least about 20 wt. % of the microcapsule; and/or
wherein a total weight of (ii) diflufenican is at least about 1.0 wt. % of the microcapsule.

9.-10. (canceled)

11. The microcapsule of claim 1, wherein the water-immiscible core material comprises one or more further herbicides comprising a Photosystem II inhibitor.

12. The microcapsule of claim 11, wherein a total weight of the Photosystem II inhibitor is at least about 4.5 wt. % of the microcapsule.

13.-14. (canceled)

15. The microcapsule of claim 1, wherein a total weight of the microencapsulated herbicides is in the range of from about 15 wt. % to about 60 wt. % of the microcapsule.

16. The microcapsule of claim 1, wherein the water-immiscible core material further comprises a herbicide safener selected from the group consisting of benoxacor, cloquintocet-methyl, cloquintocet-mexyl, cyprosulfamide, fenchlorazole-ethyl, furilazole, isoxadifen-ethyl and mefenpyr-diethyl.

17. The microcapsule of claim 1, wherein a ratio by weight of a total weight of the (i) acetamide herbicide to a total weight of the (iii) organic non-polar solvents in said microcapsule is in the range of 3:2 to 20:1; and/or
wherein a total weight of the (i) acetamide herbicide and the (iii) organic non-polar solvents is at least about 25 wt. % of the microcapsule.

18. (canceled)

19. The microcapsule of claim 1, wherein the (iii) organic non-polar solvent comprises aromatic hydrocarbons, fatty acid dimethylamides, fatty acid esters, and mixtures thereof.

20. (canceled)

21. The microcapsule of claim 1, wherein the (iii) organic non-polar solvent comprises N,N-dimethyloctanamide, N,N-dimethyldecanamide and mixtures thereof.

22. The microcapsule of claim 1, wherein a total weight of the (iii) organic non-polar solvent is at least about 5 wt. % of the microcapsule.

23. (canceled)

24. The microcapsule of claim 1, wherein the polymeric shell wall comprises organic polymers selected from the group consisting of polyurea, polyurethane, polycarbonate, polyamide, polyester and polysulfonamide, and mixtures thereof.

25.-29. (canceled)

30. The microcapsule of claim 1, wherein the polymeric shell wall is a polyurea shell wall formed in a polymerization medium by a polymerization reaction between a polyisocyanate component comprising a polyisocyanate or mixture of polyisocyanates and a polyamine component comprising a polyamine or mixture of polyamines to form the polyuria, and wherein a ratio of amine molar equivalents contained in the polyamine component to isocyanate molar equivalents contained in the polyisocyanate component is from about 1.01:1 to about 1.3:1.

31. A method of making a microcapsule of claim 1, wherein the microcapsule is a polyurea core-shell microcapsule, the method comprising the steps of:
(a) preparing a liquid mixture by dissolving diflufenican, and optionally a further herbicide, in a mixture comprising acetamide herbicide(s), and an organic non-polar solvent or mixture of organic non-polar solvents at a temperature in the range of from about 50 to about 75° C.;
(b) adding a polyisocyanate component into the liquid mixture of step (a);
(c) preparing an emulsifier-containing aqueous solution, wherein a total amount of the emulsifier is in the range of from about 0.5 to about 5% by weight;
(d) heating the emulsifier-containing aqueous solution of step (c) to a temperature in the range of from about 50 to about 75° C.;
(e) adding the liquid mixture resulting from step (b) into the heated emulsifier-containing aqueous solution of step (d), under mixing;
(f) adding a polyamine component into the emulsion resulting from step (e) under agitation and keeping the emulsion at a temperature in the range of from about 50 to about 75° C. for about 30 minutes to about 120 minutes;
(g) cooling the mixture resulting from step (f), preferably to a temperature in the range of from about 10 to about 35° C.

32. The method of claim 31, wherein a ratio of amine molar equivalents contained in the polyamine component to isocyanate molar equivalents contained in the polyisocyanate component is from about 1:01 to about 1.2:1.

33. A herbicidal composition comprising the microcapsule of claim 1.

34. The herbicidal composition of claim 33, wherein the composition is in the form of a concentrate and/or a diluted spray application mixture.

35. (canceled)

36. The herbicidal composition of claim 33, wherein the composition comprises an aqueous phase.

37. The herbicidal composition of claim 33, wherein multiple ones of the microcapsule of claim 1 are dispersed therein.

38. The herbicidal composition of claim 33, wherein the composition comprises one or more of the following: further adjuvants, formulation auxiliaries or additives customary in crop protection, pesticides, safeners, emulsifiers, and/or formulation adjuvants, wherein the formulation adjuvants are selected from anti-freezing agents, substances for controlling microorganism growth, and stabilizers to help physically stabilize the formulation and/or for controlling the formulation viscosity.

39.-41. (canceled)

42. A method of making the herbicidal composition of claim 33 in the form of a diluted spray application mixture, the method comprising pouring a concentrate of the composition into a water contained vessel under agitation.

43. The method according to claim 42, wherein the amount of water used is such that a concentration of acetochlor in the resulting diluted spray application mixture is in a range of from about 0.7% to about 1.5% by weight.

44. The method according to claim 42, wherein a ratio by weight of water to concentrate is in a range of from about 1:50 to about 1:10.

45. A method for controlling undesired vegetation in a field, the method comprising applying to the field the herbicidal composition of claim 33 or a dilution thereof.

46. The method of claim 45, wherein the field further includes a crop plant, and wherein the crop plant is selected from the group consisting of soybean, corn, canola, cotton, peanuts, potatoes, sugarbeets and/or wheat.

47.-48. (canceled)

49. The method of claim 45, wherein the application mixture is applied to the field prior to (i) planting a crop plant in the field, (ii) pre-emergence to the crop plant in the field, and/or (iii) post-emergence of the crop plant in the field.

50. (canceled)

51. The method of claim 46, wherein the crop plant has one or more herbicide tolerant traits.

52. (canceled)

53. The method of claim 45, wherein the method is carried out for controlling weeds or plants having a resistance to herbicides of one, two, three, four, five or more different Modes of Action, and wherein the resistances are selected from the group consisting of auxin resistance, glyphosate resistance, acetolactate synthase (ALS) inhibitor resistance, 4-hydroxyphenylpyruvate dioxygenase (HPPD) inhibitor resistance, CoA carboxylase (ACCase) inhibitor resistance, photosystem I (PS I) inhibitor resistance, photosystem II (PS II) inhibitor resistance, protoporphyrinogen oxidase (PPO) inhibitor resistance, phytoene desaturase (PDS) inhibitor resistance and synthesis of very long-chain fatty acid (VLCFA) inhibitor resistance.

54. (canceled)

55. A composition suitable to be used as water-immiscible core material for producing the microcapsule according to claim 1, wherein the composition comprises:
(i) an acetamide herbicide;
(ii) diflufenican; and
(iii) an organic non-polar solvent; and optionally
(iv) metribuzin.
